(19) United States
(12) Patent Application Publication
(10) Pub. No.: US 2016/0156516 A1
(43) Pub. Date: Jun. 2, 2016

(54) MONITORING DEVICE, METHOD, AND MEDIUM

(71) Applicant: FUJITSU LIMITED, Kawasaki-shi (JP)

(72) Inventor: Tetsuya NISHI, Kawasaki (JP)

(21) Appl. No.: 14/952,083

(22) Filed: Nov. 25, 2015

(30) Foreign Application Priority Data
Nov. 28, 2014 (JP) 2014-242011

(51) Int. Cl. H04L 12/24; H04L 12/26; H04L 12/755

(52) U.S. Cl. CPC H04L 41/0816; H04L 45/021; H04L 43/0829

(57) ABSTRACT

A monitoring device includes: a memory configured to store association information indicating associations between a set of indication values, which are calculated by a predetermined calculation of addresses included in packets, and a plurality of physical links used to transfer the packets, the packets being transferred between two relay devices through a link aggregation that forms a logical link by aggregating the plurality of physical links; and a processor coupled to the memory and configured to: collect the packets which is transferred through the logical link; acquire the indication values of the collected packets in association with corresponding physical link; determine whether or not the association information of the link aggregation is to be changed based on time interval of times at which a set of the acquired indication values, which is associated with one of the plurality of physical links, are acquired.

### CROSS-REFERENCE TO RELATED APPLICATION

This application is based upon and claims the benefit of priority of the prior Japanese Patent Application No. 2014-242011, filed on Nov. 28, 2014, the entire contents of which are incorporated herein by reference.

### FIELD

The embodiments discussed herein are related to a monitoring device, a method, and a medium.

### BACKGROUND

In the information processing system, various information processing devices such as a client computer or a server computer are coupled to each other via the network and perform data communication. The network includes plural relay devices. For example, a communication path (physical link) is formed by using a predetermined cable that couples a port of a certain relay device and a port of another relay device. Based on the address included in the packet to be transmitted, the relay device selects a port for sending the packet. As the address, for example, a media access control (MAC) address is used on Layer 2 of an open systems interconnection (OSI) reference model. An internet protocol (IP) address is used on Layer 3 of the OSI reference model.

In addition, a technique called link aggregation has been known as a method of improving communication quality between relay devices. The link aggregation is a technique of providing plural physical links between two relay devices and forming one logical link by bundling (aggregating) plural physical links. If the link aggregation is used, a communication path having higher speed than one physical link may be realized. In addition, since plural physical links may be used at the same time, even if a portion of the physical links is out of order, complete disconnection of the communication path may be inhibited and availability may be improved.

In the link aggregation, hash calculation is performed based on the address included in the packet in the relay device, and physical links of an output destination are decided from the calculated hash values, in many cases. This is because the sequence inversion of information strings does not occur owing that information strings to be transmitted from a certain transmission terminal to a destination terminal are transmitted on one physical link.

However, in the information processing system, the communication quality is monitored in some cases. For example, it is suggested that the transmission quality for a communication with a specific user may be monitored by using a function called Ethernet-Link Trace (Eth-LT) (Ethernet is registered trademark), when a link aggregation group including plural physical links is configured. In this case, MAC header information in a user MAC frame or MAC header information in a transmission quality monitoring frame for monitoring transmission quality is added to a link trace message (LTM) of Eth-LT. When LTM is sent to any one of the physical links belonging to the link aggregation group, the layer 2 switch which receives LTM decides a physical link of a sending destination by using the MAC header information of a user MAC frame included in LTM. The layer 2 switch additionally sets a load balancing rule such that a transmission quality monitoring frame is sent to the physical link which is the same as the decided sending destination. Further, the layer 2 switch adds a physical link identifier of the decided sending destination to a link trace reply (LTR) which is a reply to LTM, and responds to the transmission source of LTM.

As an example of the related art, Japanese Laid-open Patent Publication No. 2013-223179 has been known.

### SUMMARY

According to an aspect of the invention, a monitoring device includes: a memory configured to store association information indicating associations between a set of indication values, which are calculated by a predetermined calculation of addresses included in packets, and a plurality of physical links used to transfer the packets, the packets being transferred between two relay devices through a link aggregation that forms a logical link by aggregating the plurality of physical links; and a processor coupled to the memory and configured to: collect the packets which is transferred through the logical link; acquire the indication values of the collected packets in association with corresponding physical link; determine whether or not the association information of the link aggregation is to be changed based on time interval of times at which a set of the acquired indication values, which is associated with one of the plurality of physical links, are acquired; and change the association information stored in the memory in a case that the association information is determined to be changed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a monitoring device according to a first embodiment;

FIGS. 2A and 2B are diagrams illustrating a monitoring example after link-down according to the first embodiment;

FIG. 3 is a flow chart illustrating a monitoring example according to the first embodiment;

FIG. 4 is a diagram illustrating a monitoring device according to a second embodiment;

FIGS. 5A, 5B, and 5C are diagrams illustrating a monitoring example according to the second embodiment;

FIGS. 6A, 6B, and 6C are diagrams illustrating another monitoring example according to the second embodiment;

FIG. 7 is a flow chart illustrating a monitoring example according to the second embodiment;

FIG. 8 is a diagram illustrating an information processing system according to a third embodiment;

FIG. 9 is a diagram illustrating a hardware example of a monitoring server according to the third embodiment;

FIG. 10 is a diagram illustrating a function example of the monitoring server according to the third embodiment;

FIG. 11 is a diagram illustrating an example of an IP header according to the third embodiment;

FIG. 12 is a diagram illustrating an example of a sorting table according to the third embodiment;

FIG. 13 is a diagram illustrating an example of a GUI according to the third embodiment;

FIG. 14 is a diagram illustrating an example of rule registration data according to the third embodiment;

FIG. 15 is a diagram illustrating an example of a failure management table according to the third embodiment;

FIG. 16 is a diagram illustrating a quality measurement result table according to the third embodiment;

FIG. 17 is a flow chart illustrating a monitoring example according to the third embodiment;

FIG. 18 is a (first) monitoring example according to the third embodiment;

FIG. 19 is a (second) monitoring example according to the third embodiment;

FIG. 20 is a (third) monitoring example according to the third embodiment; and

FIG. 21 is a (continuation of the third) monitoring example according to the third embodiment.

### DESCRIPTION OF EMBODIMENTS

It is considered that packets transmitted by a certain relay device are collected by a monitoring device, and deterioration in communication qualities in the network such as packet losses is monitored based on the collected packets. If the information collection point is localized, a network may be effectively monitored compared with a case in which information for monitoring is separately collected from respective relay devices.

If there is a section (hereinafter, referred to as “link aggregation section”) between two relay devices coupled by a link aggregation group in the network, it is considered that a communication quality for each physical link in the link aggregation section is monitored based on collected packets. For example, information on sorting rules of hash values for physical links is stored in a monitoring device. If hash values corresponding to certain physical links in the sorting rules are the only hash values calculated from packets in a communication having quality deterioration, the monitoring device may determine that communication qualities in the physical links are possibly deteriorated.

However, sorting rules may not be the same all the time. The relay device may change a sorting rule of hash values for the physical links. As timing for changing the rule, for example, a timing at which any one of the physical links of the link aggregation section becomes unavailable due to failure or a timing at which a communication is restarted at a physical link restored from failure is included.

If monitoring is performed by using a rule before a change even though a sorting rule is changed, which physical link has communication quality deterioration may not be properly determined. Therefore, a method of recognizing a change of a sorting rule in the link aggregation section from the collected packet does matter.

In addition, a method of changing a sorting rule varies according to a vendor of a relay device. Therefore, if a user is forced to create information on the correlation between hash values and physical links of an output destination for each switch of a monitoring target and to input the information to a monitoring device, a workload of a user may increase.

According to an aspect, an object of the embodiment is to provide a technique of recognizing a change of a sorting rule in a link aggregation section.

According to another aspect, an object of the embodiment is to support a setting work for monitoring by a user.

Hereinafter, embodiments are described with reference to the drawings.

### First Embodiment

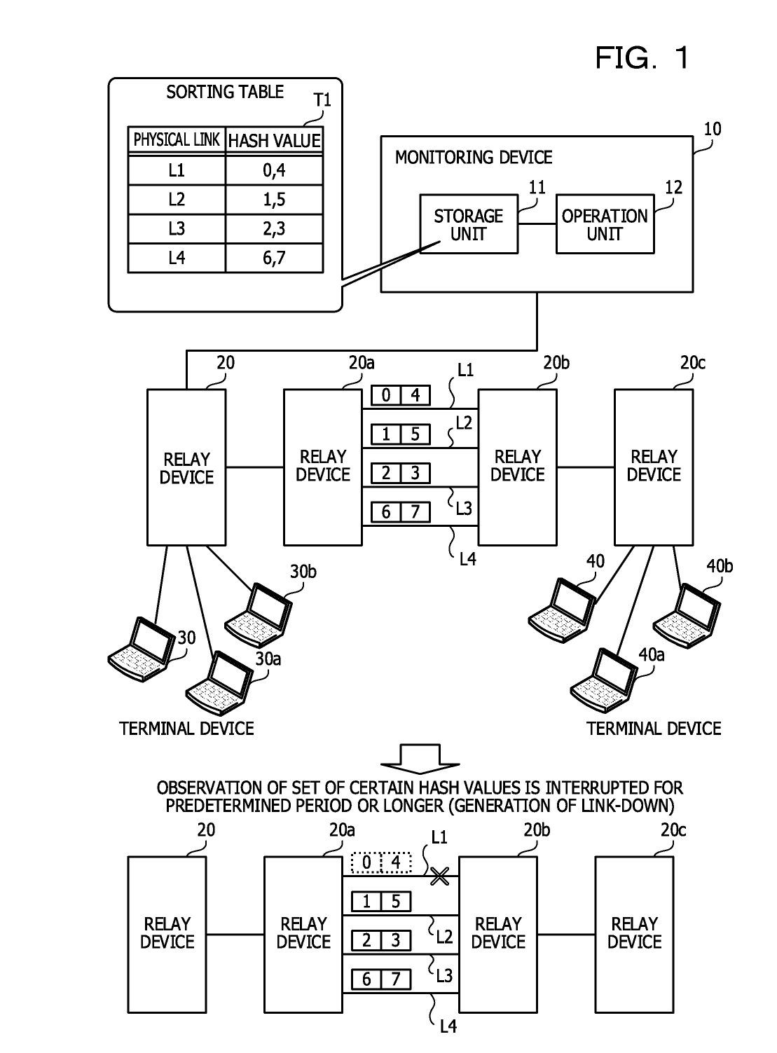

FIG. 1 is a diagram illustrating a monitoring device according to a first embodiment. A monitoring device 10 monitors communication qualities of the network formed with relay devices 20, 20a, 20b, and 20c. The relay devices 20, 20a, 20b, and 20c are, for example, layer 2 switches or layer 3 switches. The monitoring device 10 is coupled to the relay device 20. The monitoring device 10 collects packets transmitted via the network, from the relay device 20. The monitoring device 10 monitors communication qualities of the network based on the collected packets.

The relay devices 20 and 20a are coupled to each other via one cable (for example, twisted pair (TP) cable or optical cable). That is, there is one physical link between the relay devices 20 and 20a. The relay devices 20a and 20b are coupled to each other via four cables. That is, there are four physical links L1, L2, L3, and L4 between the relay devices 20a and 20b. The relay devices 20b and 20c are coupled to each other via one cable. That is, there is one physical link between the relay devices 20a and 20b.

The relay device 20 is coupled to the monitoring device 10 and terminal devices 30, 30a, and 30b. The relay device 20c is coupled to terminal devices 40, 40a, and 40b. The terminal devices 30, 30a, 30b, 40, 40a, and 40b are, for example, client computers or server computers. The terminal devices 30, 30a, 30b, 40, 40a, and 40b may communicate with each other via the relay devices 20, 20a, 20b, and 20c.

The relay devices 20a and 20b bundle physical links L1, L2, L3, and L4 by a technique of link aggregation, and deal the physical links L1, L2, L3, and L4 as one logical link. The link aggregation is regulated by Institute of Electrical and Electronics Engineers (IEEE) 802.1ax. A group of the physical links L1, L2, L3, and L4 bundled to one logical link is called a link aggregation group (LAG). A section between the relay devices 20a and 20b in which LAG exists may be called a link aggregation section. In the physical links L1, L2, L3, and L4, automatic restoration from link-down caused by failure and from a down caused by the relay devices 20a and 20b may occur. The relay devices 20a and 20b communicate with each other by using a link aggregation control protocol (LACP), and when a failure was generated in a portion of physical links, the relay devices 20a and 20b sort hash values of the physical links which went down, to normal physical links. In addition, the relay devices 20a and 20b re-sort the hash values to the physical links restored from the link-failure.

The relay devices 20a and 20b decide which of the physical links L1, L2, L3, and L4 is to be used for transmitting packets transmitted and received between terminal devices, based on the hash values calculated from addresses included in the packets. The relay devices 20a and 20b calculate one hash value for one set of a source address and a destination address by a predetermined hash algorithm (also referred to as hash function). The relay devices 20a and 20b use IP addresses as addresses for hash calculation. MAC addresses may be used as addresses for hash calculation.

For example, the relay devices 20a and 20b equally sort eight hash values (0, 1, 2, 3, 4, 5, 6, and 7) to the physical links L1, L2, L3, and L4 by two hash values for each physical link in a state in which all the physical links L1, L2, L3, and L4 are active. The correlation between the physical link and the hash value is one-to-many (in this example, one-to-two). For example, a set of hash values (0, 4) is sorted to the physical link L1. A set of hash values (1, 5) is sorted to the physical link L2. A set of hash values (2, 3) is sorted to the physical link L3. A set of hash values (6, 7) is sorted to the physical link L4.

If failure occurs in a portion of the physical links L1, L2, L3, and L4, the relay devices 20a and 20b change a correlation between a physical link and a hash value. Specifically, if a physical link went down due to failure, two hash values which are sorted to the physical links in which failure occurs are re-sorted to another normal physical link. In addition, if the physical link which went down is restored, any two of the hash values are re-sorted to the restored physical link, such that the numbers of hash values for respective physical links are equal.

The monitoring device 10 determines a change in correlation between physical links and hash values in a link aggregation section based on the packets collected from the relay device 20, as follows. The monitoring device 10 has a storage unit 11 and an operation unit 12.

The storage unit 11 may be a volatile storage device such as a random access memory (RAM) or may be a non-volatile storage device such as a hard disk drive (HDD) or a flash memory. The operation unit 12 may include a central processing unit (CPU), a digital signal processor (DSP), an application specific integrated circuit (ASIC), a field programmable gate array (FPGA), and the like. The operation unit 12 may be a processor that executes a program. The “processor” may include a set of plural processors (multi-processor).

The storage unit 11 stores a sorting table T1. The sorting table T1 is association information indicating associations between the addresses included in the packets and the physical links through which the packets are output, among the physical links L1, L2, L3, and L4. The sorting table T1 indicates one-to-many correlation between physical links and hash values calculated from the addresses. The sorting table T1 includes information on the following correlation between the physical link and the sets of the hash values. The first row is an association between the physical link L1 and the set of hash values (0, 4). The second row is an association between the physical link L2 and the set of hash values (1, 5). The third row is an association between the physical link L3 and the set of hash values (2, 3). The fourth row is an association between the physical link L4 and the set of hash values (6, 7).

The storage unit 11 stores information (physical topology information) of physical links existing between the relay devices 20, 20a, 20b, and 20c, in advance. For example, the operation unit 12 collects information relating to a link layer discovery protocol (LLDP) or a Cisco discovery protocol (CDP) (herein, CISCO is a registered trademark) from the relay devices 20, 20a, 20b, and 20c, and recognizes physical topology, existence of a link aggregation section, or the like.

The operation unit 12 continuously collects packets transmitted via the network from the relay device 20. The operation unit 12 may collect packets by using the port mirroring function of the relay device 20. Specifically, the relay device 20 duplicates packets passing through a port coupled to the relay device 20a and continuously sends the packets from the port coupled to the monitoring device 10. The operation unit 12 collects packets reaching the monitoring device 10.

The operation unit 12 acquires hash values corresponding to the collected packets. The operation unit 12 calculates the hash values corresponding to the sets of the source addresses and the destination addresses included in the packets by using the hash algorithm which is the same as the hash algorithm used by the relay devices 20a and 20b. The operation unit 12 acquires the hash values corresponding to the collected packets whenever the packets are collected.

The operation unit 12 specifies a first set of hash value of which the acquisition is interrupted, for a period of a certain length t or greater. The communication corresponding to the hash value belonging to the first set was transmitting a packet at the time right before the corresponding period, but transmission of the packet for the period or more is interrupted. The operation unit 12 refers to the storage unit 11 and searches a set which is completely identical to the first set among the sets of the hash values corresponding to the respective physical links L1, L2, L3, and L4. If there is a set which is identical to the first set, the operation unit 12 determines that the correlation in the link aggregation section changes.

Here, if any one of the physical links went down due to failure, the relay devices 20a and 20b perform control such that packets to pass through the physical link which went down is to be transmitted via another normal physical link, after waiting for a certain period (waiting period). In this case, the relay devices 20a and 20b use a sorting rule different from the sorting table T1. The monitoring device 10 detects a change of a sorting rule in the link aggregation section, by detecting a possibility of link-down of any one of the physical links, from the collected packets.

The length of the waiting period for the relay devices 20a and 20b is, for example, one second to several seconds, and varies according to a vendor (company selling product) or the like of the relay device. The reason that the relay devices 20a and 20b stand by for a waiting period and change the physical link to the normal physical link is to inhibit sequence inversion of packets to be transmitted by the relay devices 20a and 20b.

The length t is decided in response to the length of the waiting period for the relay devices 20a and 20b. Specifically, the length t may be set to a length which is the same as the waiting period. However, the length t may be different from the length of the waiting period (for example, a length shorter than waiting period in a certain rate).

For example, the operation unit 12 specifies a set of hash values (0, 4) as a first set of hash values of which acquisition is interrupted for a period of the length t or longer based on the collected packets. The operation unit 12 refers to the sorting table T1 stored in the storage unit 11 and searches a set of hash values (0, 4) which is completely identical to the first set (0, 4). A set (0, 4) which is identical to the first set exists in the sorting table T1. In this case, there is a possibility that link-down occurs in the physical link L1 corresponding to the set of hash values (0, 4).

Accordingly, the operation unit 12 determines that correlation between the physical link and the hash value in the link aggregation section changes (changes to a sorting rule different from the rule represented by the sorting table T1). Accordingly, the change of the sorting rule in the link aggregation section may be appropriately recognized.

Thereafter, monitoring may be performed in response to the change of the sorting rule. Specifically, in the example above, in preparation for a case in which link-down of the physical link L1 is detected, an after-restoration sorting rule to be used after the link restoration may be stored in the storage unit 11 in advance. Then, when deterioration of the communication quality is observed, the operation unit 12 refers to the after-restoration sorting rule, and detects which physical link in the link aggregation section has deteriorated quality.

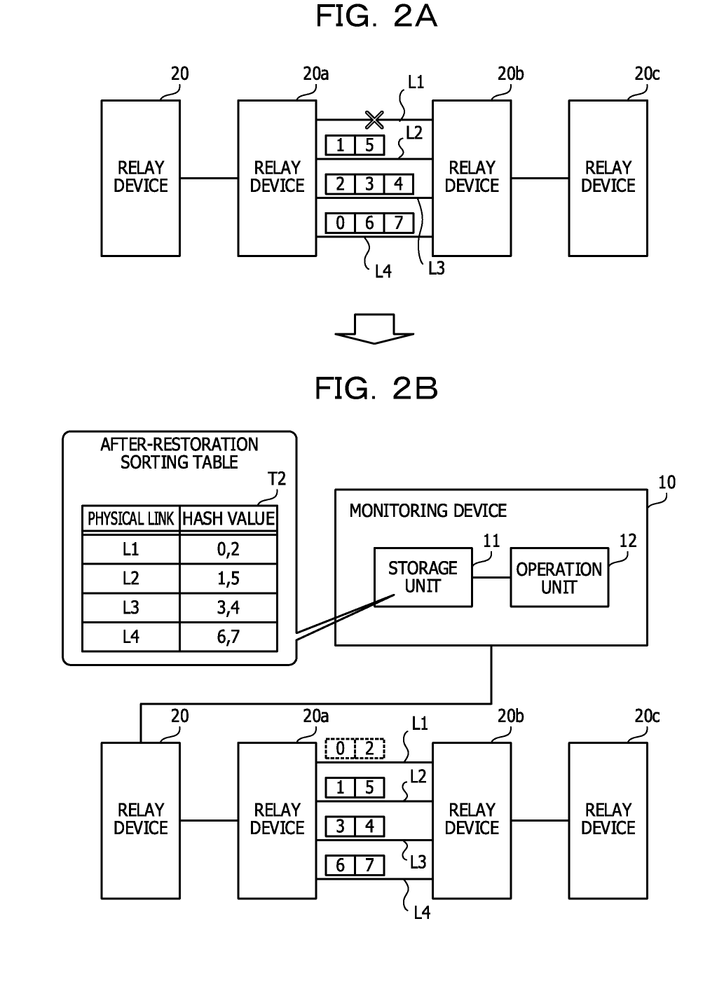

FIGS. 2A and 2B are diagrams illustrating a monitoring example after link-down according to the first embodiment. For example, when the physical link L1 has link-down, the hash value “4” sorted to the physical link L1 is sorted to the physical link L3, and the same hash value “0” is sorted to the physical link L4 (FIG. 2A). Thereafter, the physical link L1 is restored from failure, by an automatic restoration function of the relay devices 20a and 20b.

If the physical link L1 is restored from failure, any two of the hash values sorted to the physical links L2, L3, and L4 are sorted to the physical link L1. For example, a set of hash values (0, 2) is sorted to the physical link L1. A set of hash values (1, 5) is sorted to the physical link L2. A set of hash values (3, 4) is sorted to the physical link L3. A set of hash values (6, 7) is sorted to the physical link L3.

Therefore, for example, in association with the sorting table T1, the respective physical links L1, L2, L3, and L4 go down due to failure and restored from the failure, an after-restoration sorting table T2 may be stored in the storage unit 11, in advance. The after-restoration sorting table T2 may be obtained by preliminary operation verification or the like, by using the relay devices 20a and 20b. For example, the after-restoration sorting table T2 of the physical link L1 associates physical links and sets of hash values, respectively, as follows. The first row is an association between the physical link L1 and the set of hash values (0, 2). The second row is an association between the physical link L2 and the set of hash values (1, 5). The third row is an association between the physical link L3 and the set of hash values (3, 4). The fourth row is an association between the physical link L4 and the set of hash values (6, 7).

Thereafter, the operation unit 12 detects the generation of quality deterioration in a communication having hash values “0” and “2”, from the collected packets (FIG. 2B). Here, the quality deterioration of the communication may be detected, for example, by the determination on whether a rate of the number of lost packets to the number of transmitted and received packets is equal to or greater than a threshold value (loss rate of packets). If the loss rate of the packets is equal to or greater than the threshold value, quality deterioration is generated, and if the loss rate of the packets is less than the threshold value, quality deterioration is not generated.

Then, the operation unit 12 refers to the after-restoration sorting table T2, which is stored in the storage unit 11 and searches the set of hash values (0, 2). As described below, in the after-restoration sorting table T2, the set of hash values (0, 2) is associated with the physical link L1. Accordingly, the operation unit 12 may detect quality deterioration is possibly generated in the physical link L1 in the link aggregation section.

For example, the operation unit 12 may notify the detection result to a system operator and may support a specific operation by the operator in a section in which a communication quality is deteriorated. As the notification method, for example, a method of displaying a message or an image for notification on a display device coupled to the monitoring device 10 that transmits a message for notification to an account used by the system operator, or the like may be used. Then, the system operator may read notification contents, examine the relay devices 20a and 20b, and perform an operation of improving the communication quality.

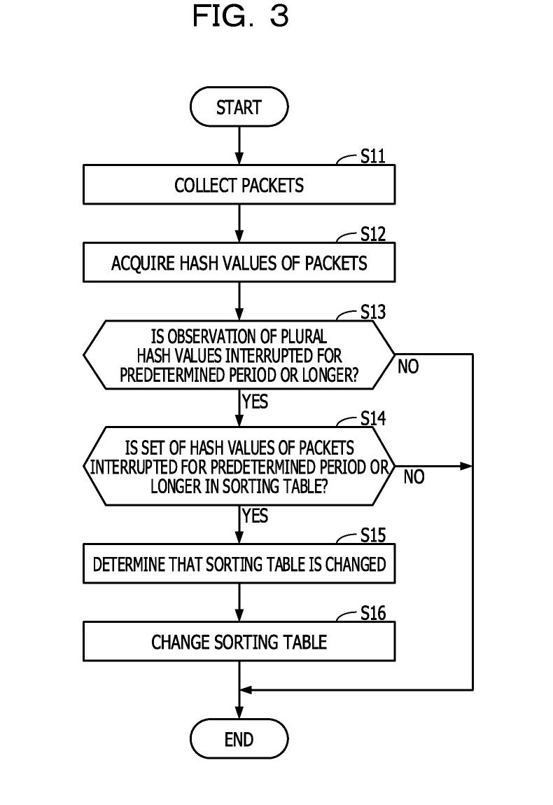

FIG. 3 is a flow chart illustrating a monitoring example according to the first embodiment. Hereinafter, processes illustrated in FIG. 3 are described according to step numbers. Right before S11, a sorting table applied for monitoring in the monitoring device 10 is the sorting table T1. In addition, the after-restoration sorting table T2 is also stored in the storage unit 11, in advance.

(S11) The operation unit 12 collects packets flowing through a link aggregation section between the relay devices 20a and 20b. For example, the operation unit 12 uses a port mirroring function of the relay device 20 (another relay device may be used) and collects the packets. The collection period is, for example, 1 minute (another length such as two minutes or five minutes may be used). The operation unit 12 stores the respective collected packets in the storage unit 11, in association with the acquisition time.

(S12) The operation unit 12 acquires hash values based on the packets collected in S11. Specifically, the operation unit 12 obtains the hash values by substituting sets of source IP addresses (a portion of values may be used) and destination IP addresses (a portion of values may be used) included in the packets to the hash function. As a result, the operation unit 12 sequentially acquires hash values in association with the packets at respective points in time.

(S13) The operation unit 12 determines whether the observation of the plural hash values is interrupted for a predetermined period or longer based on the acquisition results of the hash values in S12. If the observation of the plural hash values is interrupted for a predetermined period (the length t) or longer, the process proceeds to S14. If the observation of the plural hash values is not interrupted for a predetermined period or longer, the process ends. If the observation of the plural hash values is interrupted for a predetermined period or longer, failure is possibly generated in any one of the physical links.

(S14) The operation unit 12 determines whether a set of hash values in the packets interrupted for the predetermined period of the length t or longer exists in the sorting table T1, as a set of hash values associated with any one of the physical links. If the set of hash values exists, the process proceeds to S15. If not, the process ends. For example, if the set of hash values of which observation is interrupted for a predetermined period or longer is (0, 4), the operation unit 12 determines that the set of hash values (0, 4) associated with the physical link L1 exists in the sorting table T1.

(S15) The operation unit 12 determines whether the sorting table T1 is changed by failure of the physical link in the link aggregation section. For example, if the set of hash values of which the observation is interrupted for a predetermined period or longer is (0, 4), the operation unit 12 determines that failure was generated in the physical link L1 associated with the set of hash values (0, 4), from the sorting table T1. The operation unit 12 specifies the after-restoration sorting table T2 for failure of the physical link L1.

(S16) The operation unit 12 changes the sorting table used for monitoring a communication quality to the sorting table T2 from the sorting table T1. The timing for the change may be a time at which a certain period (for example, time at which the automatic restoration of failure in the physical link between the relay devices 20a and 20b is expected to be completed) has elapsed after the failure in the physical link in S15 is detected.

In this manner, the monitoring device 10 determines whether a sorting table in a link aggregation section is changed by repeatedly performing the steps described above. In addition, the monitoring device 10 may appropriately monitor a communication quality in a link aggregation section by changing a sorting table for monitoring a communication quality.

In the example according to the first embodiment, the relay devices 20, 20a, 20b, and 20c are included, but the number of relay devices in the monitoring target may be 2, 3, 5, or greater. Specifically, as the scale of the network becomes larger, the number of the relay devices in the monitoring target increases, and it becomes difficult to specify a section in which quality is deteriorated. Therefore, if the method according to the first embodiment is used, the work of the operator for specifying the section in which communication quality is deteriorated may be reduced.

In addition, in the example according to the first embodiment, the monitoring device 10 is coupled to the relay device 20, but the monitoring device 10 may be coupled to any one of the relay devices 20a, 20b, and 20c. The monitoring device 10 may recognize the change of the sorting rule in the link aggregation section in the same manner as in the first embodiment, even if packets collected from any one of the relay devices 20a, 20b, and 20c are used.

### Second Embodiment

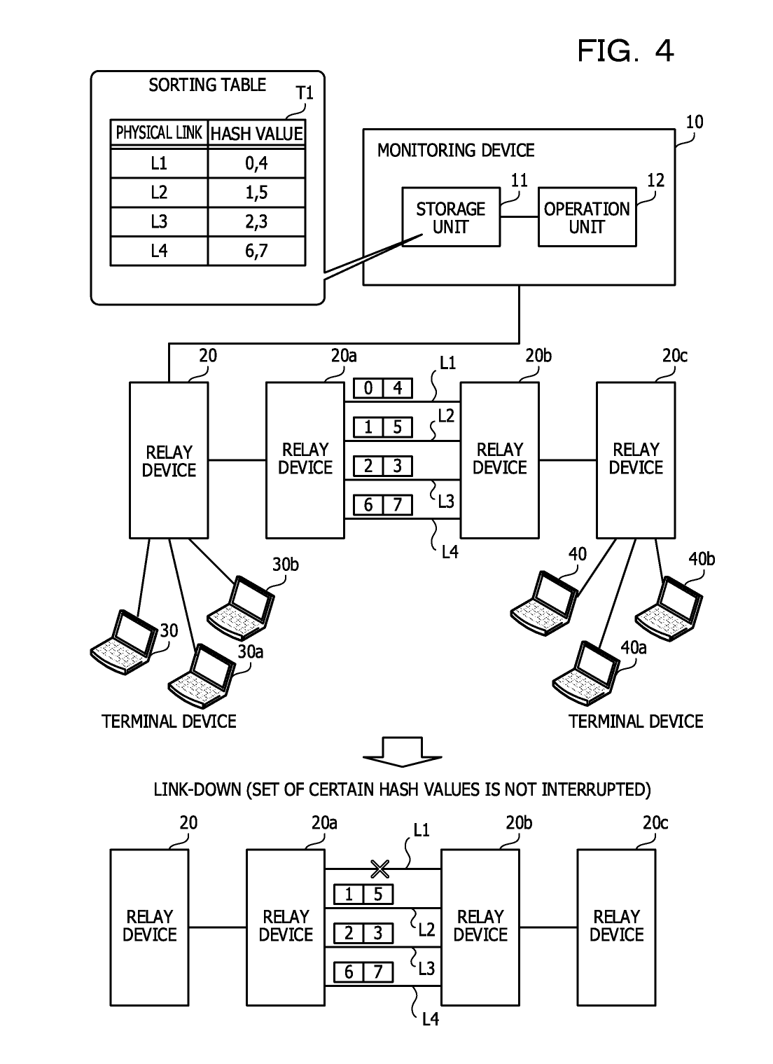

FIG. 4 is a diagram illustrating a monitoring device according to a second embodiment. Physical topology of the network according to the second embodiment is the same as that of the network according to the first embodiment, and devices and physical links which are the same as in the first embodiment are indicated by the same names and the same reference numerals.

If the method according to the first embodiment is used, when the link-down in the physical link is generated while packets are transmitted, the monitoring device 10 may recognize the change of the sorting rule in the link aggregation section. However, if the link-down is generated in the physical link in which packets are not currently transmitted, the monitoring device 10 possibly overlooks the link-down.

Therefore, according to the second embodiment, even in a case where the link-down was generated in the physical link while packets are not being transmitted, a function of determining a change of a sorting rule in a link aggregation section based on collected packets is provided.

The monitoring device 10 has the storage unit 11 and the operation unit 12. The storage unit 11 stores the sorting table T1. In addition, the storage unit 11 stores information (information on physical topology) of the physical links existing between the relay devices 20, 20a, 20b, and 20c.

The operation unit 12 continuously collects packets transmitted via the network from the relay device 20. The operation unit 12 collects packets by using a port mirroring function of the relay device 20, as described above.

The operation unit 12 acquires a hash value corresponding to the collected packets. The operation unit 12 calculates hash values according to sets of source addresses and destination addresses included in the packets, by using a hash algorithm which is the same as the hash algorithm used by the relay devices 20a and 20b. That is, the operation unit 12 acquires a hash value according to the collected packets whenever packet is collected.

The operation unit 12 specifies a first set of hash values of which acquisition is temporarily interrupted during the packet collection period. The expression “temporarily” refers to, for example, a time shorter than the time t described above. The operation unit 12 refers to the storage unit 11 and searches a set which is completely identical to the first set, among sets of hash values associated with the respective physical links L1, L2, L3, and L4. If there is no set which is identical to the first set, the operation unit 12 determines that correlation in the link aggregation section is changed. If the first set of hash value does not exist in the sorting rule which is currently referred to, the sorting rule is quite possibly changed.

Accordingly, even if the link-down was generated in the physical link in which packets are not currently transmitted, the change of the sorting rule in the link aggregation section may be recognized. Specifically, the method is as follows.

For example, it is assumed that link-down was generated in the physical link L1. At this point, this is different from the case of FIG. 1, in that packets are not currently transmitted in the physical link L1. In this case, at the timing at which link-down was generated, the operation unit 12 may not determine the change of the sorting rule (because packets passing through the physical link L1 are not collected).

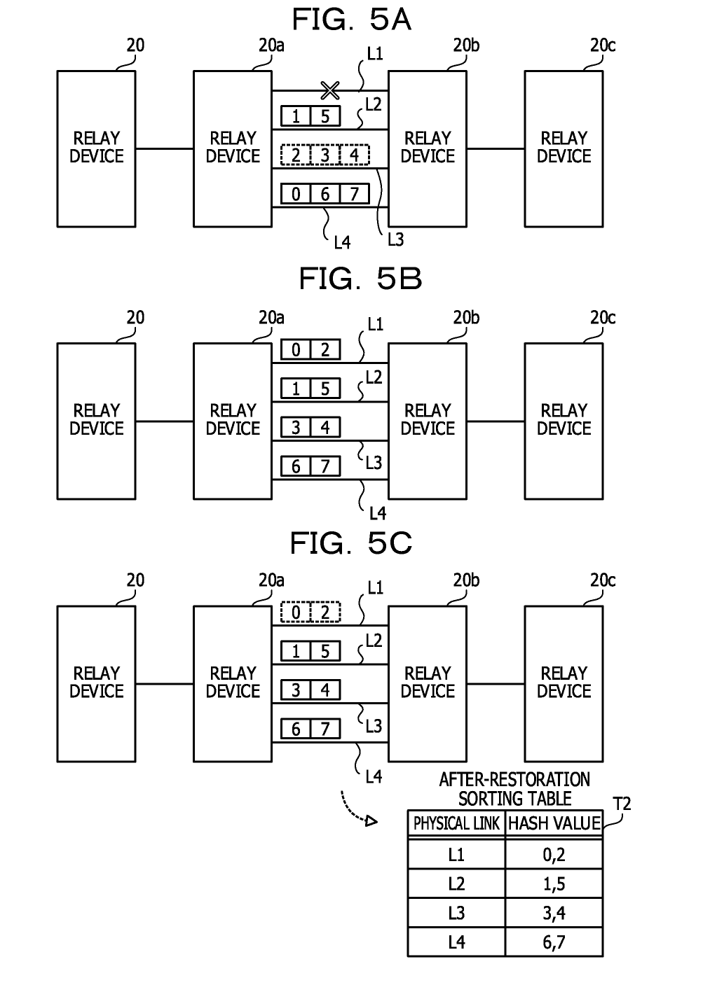

FIGS. 5A, 5B, and 5C are diagrams illustrating a monitoring example according to the second embodiment. For example, when the physical link L1 has link-down, the hash value “4” which is sorted to the physical link L1 is sorted to the physical link L3, and the hash value “0” is sorted to the physical link L4.

At this point, it is assumed that the operation unit 12 specifies a first set (2, 3, 4) of the hash values in which deterioration (for example, loss rate of packets is equal to or greater than threshold value) of a communication quality is observed based on the collected packets (FIG. 5A). The operation unit 12 refers to the sorting table T1 stored in the storage unit 11 and searches the set of hash values (2, 3, 4) which is completely identical to the first set (2, 3, 4). In the sorting table T1, a set which is identical to the first set (2, 3, 4) does not exist. Accordingly, the operation unit 12 determines that correlation between the physical links and the hash values is changed (changed to sorting rule which is different from rule indicated by the sorting table T1) in the link aggregation section.

Specifically, in this case, the set of hash values (2, 3) is registered to the sorting table T1, in association with the physical link L3. The difference between the set of hash values (2, 3, 4) and the set of hash values (2, 3) is the hash value “4”. In the sorting table T1, the hash value “4” is associated with the physical link L1 together with the hash value “0”. Accordingly, the operation unit 12 determines that the storage of the hash value “4” is changed from the physical link L1 to the physical link L3, and may determine that the physical link L1 went down by failure. That is, the operation unit 12 may detect the physical link L1 is currently in the link-down state. In addition, the operation unit 12 may detect the generation of the deterioration of the communication quality in the physical link L3.

In this manner, the monitoring device 10 may recognize the change of the sorting rule in the link aggregation section. For example, after the change of the sorting rule is detected, the operation unit 12 may continuously perform monitoring by using the after-restoration sorting table T2.

Specifically, in the example described above, if the physical link L1 is restored from failure, any two of hash values sorted to the physical links L2, L3, and L4 are sorted to the after-restoration physical link L1 (FIG. 5B). For example, the set of hash values (0, 2) is sorted to the physical link L1. The set of hash values (1, 5) is sorted to the physical link L2. The set of hash values (3, 4) is sorted to the physical link L3. The set of hash values (6, 7) is sorted to the physical link L3.

Therefore, for example, in association with the sorting table T1, after the respective physical links L1, L2, L3, and L4 went down by failure and restored from the failure, the after-restoration sorting table T2 may be stored in the storage unit 11, in advance. For example, the after-restoration sorting table T2 may be obtained by preliminary operation verification or the like, using the relay devices 20a and 20b. For example, in the after-restoration sorting table T2 for the physical link L1, the sets of the physical links and the sets of hash values are associated with each other, as follows. The first row is an association between the physical link L1 and the set of hash values (0, 2). The second row is an association between the physical link L2 and the set of hash values (1, 5). The third row is an association between the physical link L3 and the set of hash values (3, 4). The fourth row is an association between the physical link L4 and the set of hash values (6, 7).

For example, the operation unit 12 detects the generation of the deterioration of the communication quality in the communication of the hash values “0” and “2” from the collected packets (FIG. 5C). Then, the operation unit 12 refers to the after-restoration sorting table T2 stored in the storage unit 11, and searches the set of hash values (0, 2). As described above, in the after-restoration sorting table T2, the set of hash values (0, 2) is associated with the physical link L1. Accordingly, the operation unit 12 may detect that the communication quality of the physical link L1 in the link aggregation section is possibly deteriorated.

For example, the operation unit 12 may notify the detection result to a system operator and may support a specific operation by the operator at a section in which a communication quality is deteriorated. As the notification method, for example, a method of displaying a message or an image for notification on a display device coupled to the monitoring device 10 that transmits a message for notification to an account used by the system operator, or the like may be used. Then, the system operator may read notification contents, examine the relay devices 20a and 20b, and perform an operation of improving the communication quality.

In addition, as described above, the operation unit 12 may detect possibility of the generation of the quality deterioration in any one of physical links having the link-down, from the sorting table T1. Therefore, after predetermined time (for example, time at which the automatic restoration of failure in the physical link between the relay devices 20a and 20b is expected to be completed) has elapsed from the detection of the quality deterioration during the link-down, the operation unit 12 may change a table to be referred to, from the sorting table T1 to the after-restoration sorting table T2.

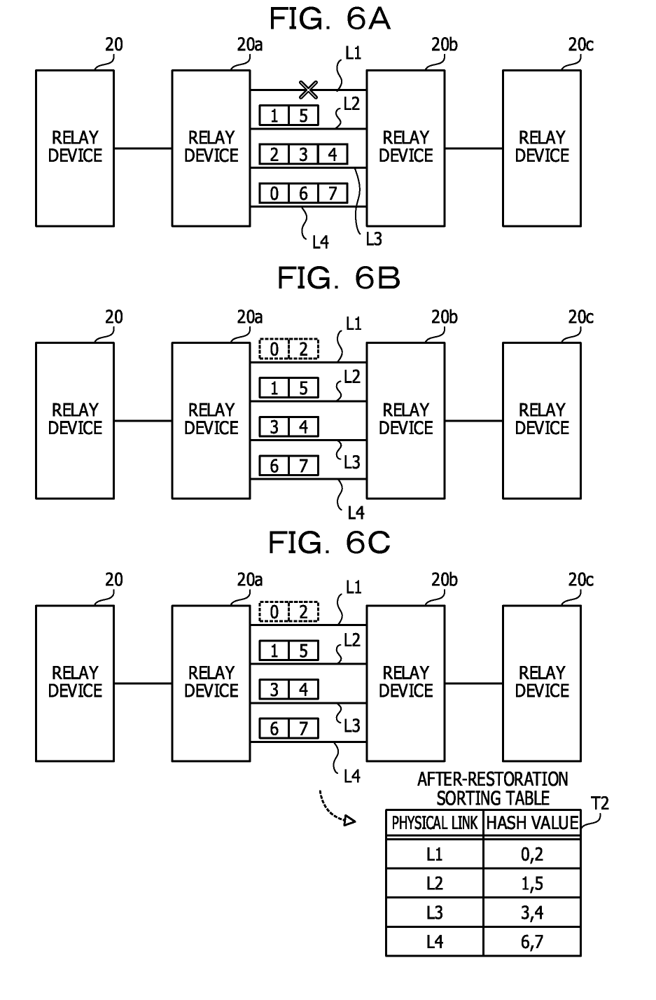

FIGS. 6A, 6B, and 6C are diagrams illustrating another monitoring example according to the second embodiment. The processes of FIGS. 6A, 6B, and 6C are performed after the generation of the link-down illustrated in FIG. 4. In the monitoring example of FIGS. 5A, 5B, and 5C, the operation unit 12 determines that the sorting rule in the link aggregation section is changed by deterioration of the communication quality detected when the physical link L1 has link-down. Meanwhile, the deterioration of the communication quality when the physical link L1 has link-down may not be detected. In this case, the operation unit 12 recognizes that the sorting rule in the link aggregation section is changed as follows.

For example, when the physical link L1 has the link-down, in the same manner as in FIG. 5A, the hash value “4” sorted to the physical link L1 is sorted to the physical link L3, and the hash value “0” is sorted to the physical link L4 (FIG. 6A). However, this is different from the case of FIG. 5A in that the deterioration of the communication quality during the link-down is not detected.

Here, when the hash values are newly sorted to the restored physical links, the relay devices 20a and 20b stops a communication associated with hash values to be sorted for a certain period (waiting period). As described above, this is performed because the transmission sequence of the packets may be inhibited from being reversed. After the waiting time has elapsed, the relay devices 20a and 20b use restored physical links and restarts the stopped communication. In the same manner as the first embodiment, the length of the waiting period is, for example, one second to several seconds, and varies according to a vendor of the relay device, or the like.

The operation unit 12 specifies the set of hash values (0, 2), as a first set of hash values of which the acquisition is interrupted for a period of the length t or longer, based on the collected packets (FIG. 6B). The length t is decided according to the waiting period. Specifically, the length t may be the same length as the waiting period. However, the length t may be different from the length of the waiting period (for example, a length shorter than waiting period in a certain rate).

The operation unit 12 refers to the sorting table T1 stored in the storage unit 11 and searches the set of hash values (0, 2) which is completely identical to the first set (0, 2). In the sorting table T1, there is no set which is identical to the first set (0, 2). Accordingly, the operation unit 12 is determined that the correlation between the physical links and the hash values in the link aggregation section is changed (changed to the sorting table T2 which is different from the rule presented in the sorting table T1).

Particularly, in this case, the number “2” of the hash value for one physical link in the sorting table T1 is identical to the number “2” of the hash value included in the first set (0, 2) of the hash value. The identical numbers of the hash values may be considered as an indication that the hash values are equally re-sorted to the physical links L1, L2, L3, and L4 by the link restoration, in the same manner as the hash values are equally sorted before the failure. Accordingly, the operation unit 12 may determine the sorting rule in the link aggregation section is further changed according to the link restoration.

As described above, the monitoring device 10 may recognize the change of the sorting rule in the link aggregation section. For example, after the change of the sorting rule is detected, the operation unit 12 may continuously perform monitoring by using the after-restoration sorting table T2. For example, in the example described above, any two of the hash values sorted to the physical links L2, L3, and L4 are sorted to the after-restoration physical link L1.

Therefore, for example, in association with the sorting table T1, after the respective physical links L1, L2, L3, and L4 went down by failure and restored from the failure, the after-restoration sorting table T2 may be stored in the storage unit 11, in advance. For example, the after-restoration sorting table T2 may be obtained by preliminary operation verification or the like, using the relay devices 20a and 20b.

Thereafter, the operation unit 12 detects that the deterioration of the communication quality was generated in the communications of the hash values “0” and “2”, from the collected packets (FIG. 6C). If the operation unit 12 may not search the set of hash values (0, 2) in which deterioration of the communication quality is detected, from the sorting table T1, the operation unit 12 searches the set of hash values (0, 2) from the after-restoration sorting table T2. If the set of hash values (0, 2) exists in the after-restoration sorting table T2, the operation unit 12 may detect that the deterioration of the communication quality is possibly generated in the physical link (for example, the physical link L1) associated with the set of hash values (0, 2) on the after-restoration sorting table T2.

For example, the operation unit 12 may notify the detection result to the system operator and may support a specific operation by the operator at a section in which a communication quality is deteriorated. As the notification method, for example, a method of displaying a message or an image for notification on a display device coupled to the monitoring device 10 that transmits a message for notification to an account used by the system operator, or the like may be used. Then, the system operator may read notification contents, examine the relay devices 20a and 20b, and perform an operation of improving the communication quality.

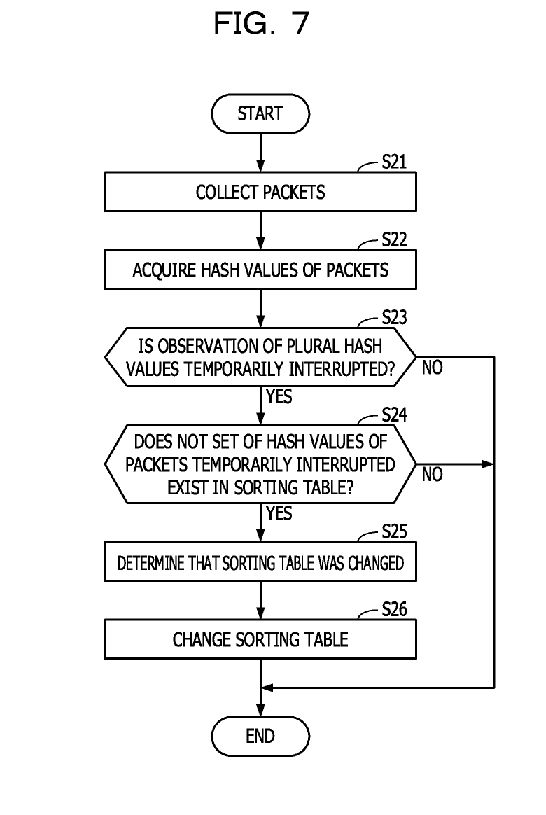

FIG. 7 is a flow chart illustrating a monitoring example according to the second embodiment. Hereinafter, processes illustrated in FIG. 7 are described according to step numbers. Right before S21, a sorting table applied for monitoring in the monitoring device 10 is the sorting table T1. In addition, the after-restoration sorting table T2 is also stored in the storage unit 11, in advance.

(S21) The operation unit 12 collects packets flowing through the link aggregation section between the relay devices 20a and 20b. For example, the operation unit 12 uses a port mirroring function of the relay device 20 (another relay device may be used) and collects the packets. The collection period is, for example, 1 minute (another length such as two minutes or five minutes may be used). The operation unit 12 stores the respective collected packets in the storage unit 11, in association with the acquisition time.

(S22) The operation unit 12 acquires hash values based on the packets collected in S21. Specifically, the operation unit 12 obtains the hash values by substituting sets of source IP addresses (a portion of values may be used) and destination IP addresses (a portion of values may be used) included in the packets to the hash function. As a result, the operation unit 12 sequentially acquires hash values in association with the packets at respective points in time.

(S23) The operation unit 12 determines the observation of the plural hash values is temporarily interrupted, based on the acquisition results of the hash values of S22. If the observation of the plural hash values is temporarily interrupted, the processes proceed to S24. If the observation of the plural hash values is not temporarily interrupted, the process ends.

(S24) The operation unit 12 determines whether the set of hash values of the packets which are temporarily interrupted exists in the sorting table T1, as the set of hash values associated with any one of physical links. If the set of hash values does not exist, the process proceeds to S25. If the set of hash values exists, the process ends (in this case, the operation unit 12 may determine that quality deterioration is possibly generated in the physical link associated with the set of sorting table T1 according to the interruption state). For example, if the set of hash values which is temporarily interrupted is (2, 3, 4), the set of hash values does not exist in the sorting table T1. Meanwhile, for example, if the set of hash values which is temporarily interrupted is (1, 5), the set of hash values (1, 5) exists in the sorting table T1.

(S25) The operation unit 12 determines that the sorting table T1 was changed by the failure of the physical link in the link aggregation section. For example, if the set of hash values which is temporarily interrupted is (2, 3, 4), the operation unit 12 determines that the failure was generated in the physical link L1 associated with the set of hash values (0, 4), from the sorting table T1. This is because the hash value “4” which is the difference between the set of hash values (2, 3) existing in the sorting table T1 and the set of hash values (2, 3, 4) which is temporarily interrupted is associated with the physical link L1 in the current sorting table T1. That is, in this case, the operation unit 12 may determine that the storage of the hash values (0, 4) is changed to another physical link, by the failure of the physical link L1. The operation unit 12 specifies the after-restoration sorting table T2 for the failure of the physical link L1.

(S26) The operation unit 12 changes a sorting table to be used for monitoring a communication quality, from the sorting table T1 to the sorting table T2. The change timing may be time after predetermined time (for example, time at which the automatic restoration of failure in the physical link between the relay devices 20a and 20b is expected to be completed) has elapsed from the detection of the failure in the physical link in S25.

In this manner, the monitoring device 10 determines the change of the sorting table in the link aggregation section. In addition, the monitoring device 10 may appropriately monitor the communication quality in the link aggregation section by changing the sorting table used in the monitoring.

In addition, in S25, as illustrated in FIG. 6B, the operation unit 12 may determine whether the number (for example, “2” if the set is (0, 2)) of the hash value when the hash value in which interruption for a predetermined period or longer is detected exists and the number (for example, “2”) of the hash value associated with each physical link in the sorting table T1 are identical to each other. If the numbers are identical to each other, the operation unit 12 may determine that the sorting table T1 is further changed by link restoration by determining that the interruption is a phenomenon at the time of link restoration, as described above.

Otherwise, if the after-restoration sorting table T2 is stored in the storage unit 11, the operation unit 12 may detect that the set of hash values (for example, (0, 2)) in which interruption for a predetermined period or longer is detected does not exist in the sorting table T1, but exists in the after-restoration sorting table T2. In this case, the operation unit 12 may determine that the sorting table T1 is further changed by link restoration. Further, the operation unit 12 may decide that the sorting table used for the monitoring is changed to the after-restoration sorting table T2 including the set of hash values (0, 2) in which interruption is detected.

In addition, in the example above, the monitoring device 10 is coupled to the relay device 20, but may be coupled to any one of the relay devices 20a, 20b, and 20c. Even if collected packets from any one of the relay devices 20a, 20b, and 20c are used, the monitoring device 10 may recognize the change of the sorting rule in the link aggregation section in the same manner as the method in the second embodiment.

### Third Embodiment

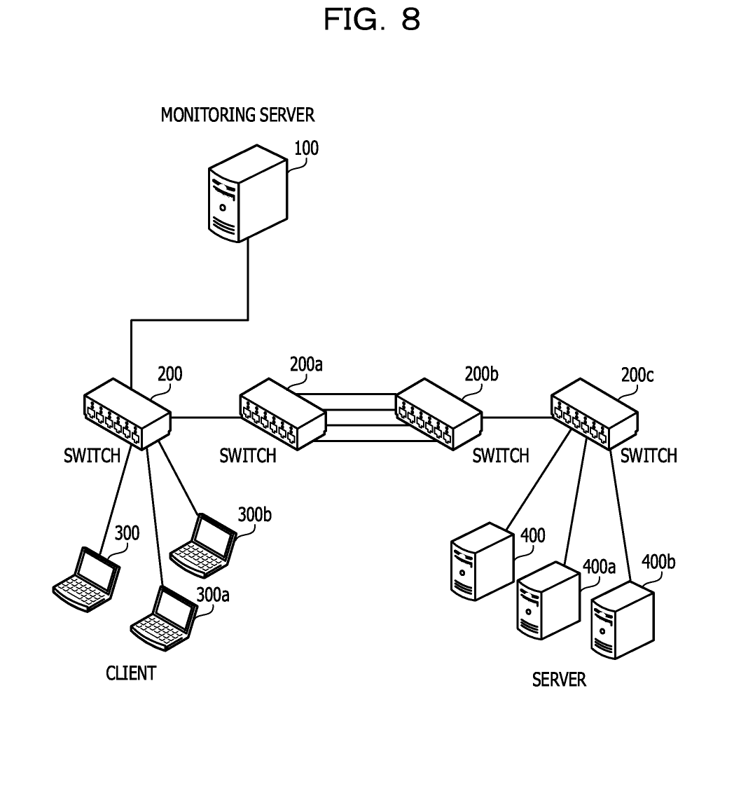

FIG. 8 is a diagram illustrating an information processing system according to a third embodiment. The information processing system according to the third embodiment has a monitoring server 100, switches 200, 200a, 200b, and 200c, clients 300, 300a, and 300b, and servers 400, 400a, and 400b. In the information processing system according to the third embodiment, users of the respective clients 300, 300a, and 300b may use various services provided by the servers 400, 400a, and 400b.

The respective devices according to the third embodiment are coupled as follows, by using predetermined cables (for example, TP cables). The monitoring server 100 is coupled to the switch 200. The clients 300, 300a, and 300b are coupled to the switch 200. The switch 200 is coupled to the switch 200a. The switch 200a is coupled to the switch 200b. The switch 200b is coupled to the switch 200c. The switch 200c is coupled to the servers 400, 400a, and 400b.

Here, the switches 200a and 200b are coupled to each other via four cables (that is, four physical links). The respective ports included in the switches 200a and 200b are identified by port numbers. Ports identified by the same port numbers of the switches 200a and 200b are coupled via one cable, to form one physical link.

The switches 200a and 200b communicate with each other by using LACP, aggregates and bundles four physical links between the switches 200a and 200b to one, and forms a link aggregation section between the switches 200a and 200b. In this case, the four physical links may be called one link aggregation group (LAG).

The monitoring server 100 is a server computer that collects and analyzes packets transmitted via the network. The monitoring server 100 supports improvements on the service quality (for example, communication speeds and quality of content distribution of voices/images) by the servers 400, 400a, and 400b, by analyzing the deterioration state of the communication quality from the collected packets.

The switches 200, 200a, 200b, and 200c are relay devices that relay communication between the clients 300, 300a, and 300b and the servers 400, 400a, and 400b. As the switches 200, 200a, 200b, and 200c, routers or Layer 3 switches that transmit packets on Layer 3 of the OSI reference model.

Here, a link aggregation section exists between the switches 200a and 200b, as described above. The switches 200a and 200b decide from which physical link belonging to the LAG, packets are to be sent based on the hash values according to the set of source IP addresses and the destination IP addresses included in the packets. The switches 200a and 200b maintains information for deciding from which physical link, packets associated with a certain hash value are to be sent. Here, a flow of the packets identified by the sets of the source IP addresses and the destination IP addresses may be called a flow.

Plural hash values (set of hash values) are associated with one physical link. If all physical links belonging to the LAG are normal, (the same numbers of) hash values are equally sorted to the respective physical links.

Physical links of any one of the switches 200a and 200b may go down by failure. If any one of the physical links went down by failure, the switches 200a and 200b sort hash values sorted to the physical link which went down, to another normal physical link. In addition, the switches 200a and 200b have a function of automatically restoring physical link which went down. If the physical link which went down is restored by failure, the switches 200a and 200b equally sort (the same number of) hash values to the respective physical links. At this point, before the link-down and after the link restoration, the sorting table T1 of the hash values by the switches 200a and 200b is changed. Therefore, the monitoring server 100 performs monitoring in consideration of the change of the sorting rule.

The clients 300, 300a, and 300b are client computers used by the user. For example, the user of the client 300 may use various services provided by the servers 400, 400a, and 400b. The respective users of the clients 300a and 300b may also use various services.

The servers 400, 400a, and 400b are server computers that provide various services to the clients 300, 300a, and 300b.

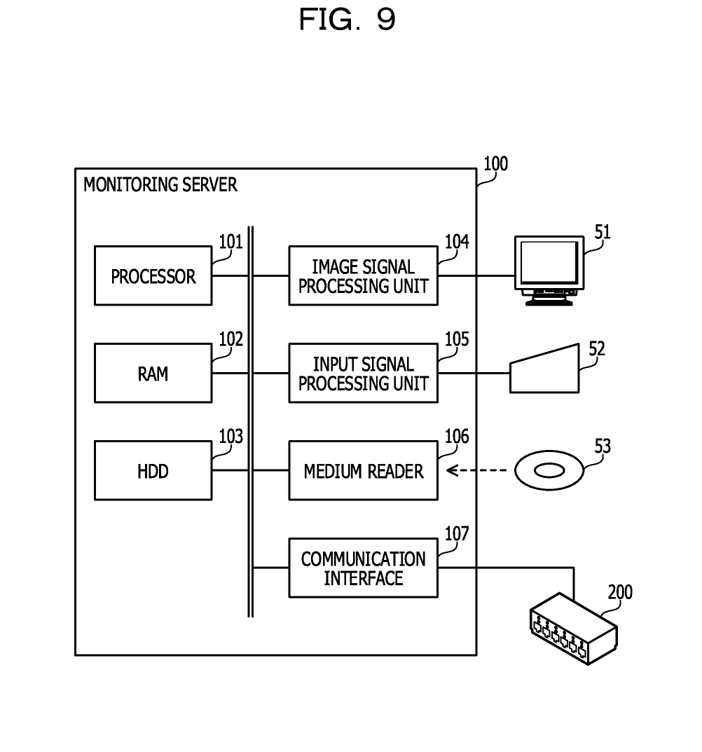

FIG. 9 is a diagram illustrating a hardware example of the monitoring server according to the third embodiment. The monitoring server 100 includes a processor 101, a RAM 102, a HDD 103, an image signal processing unit 104, an input signal processing unit 105, a medium reader 106, and a communication interface 107. The respective units are coupled to buses of the monitoring server 100. The clients 300, 300a, and 300b, and the servers 400, 400a, and 400b also may be realized by the same units as in the monitoring server 100.

The processor 101 controls an information process of the monitoring server 100. The processor 101 may be a multiprocessor. The processor 101 is, for example, CPU, DSP, ASIC, or FPGA. The processor 101 may be a combination of two or more components of CPU, DSP, ASIC, FPGA, and the like.

The RAM 102 is a main storage device of the monitoring server 100. The RAM 102 temporarily stores at least a portion of a program of an operating system (OS) executed on the processor 101 or an application program. In addition, the RAM 102 stores various items of data to be used in the process used in the processor 101.

The HDD 103 is an auxiliary storage device of the monitoring server 100. The HDD 103 magnetically writes and reads data on an embedded magnetic disc. The HDD 103 stores a program of the OS, an application program, and various kinds of data. The monitoring server 100 may include another kind of auxiliary storage devices such as a flash memory or a solid state drive (SSD), and may include plural auxiliary storage devices.

The image signal processing unit 104 outputs an image to a display 51 coupled to the monitoring server 100, in response to the instruction from the processor 101. As the display 51, a cathode ray tube (CRT) display or a liquid crystal display may be used.

The input signal processing unit 105 acquires an input signal from an input device 52 coupled to the monitoring server 100, and outputs the signal to the processor 101. As the input device 52, for example, a pointing device such as a mouse or a touch panel, or a keyboard may be used.

The medium reader 106 is a device reading a program or a data recorded on the recording medium 53. As a recording medium 53, for example, a magnetic disc such as a flexible disc (FD) or a HDD, an optical disc such as a compact disc (CD) or a digital versatile disc (DVD), and a magneto-optical disk (MO) may be used. In addition, as the recording medium 53, for example, a non-volatile semiconductor memory such as a flash memory card may be used. For example, the medium reader 106 stores a program or data read from the recording medium 53 in the RAM 102 or the HDD 103 in response to the instruction from the processor 101.

The communication interface 107 is coupled to any one of plural ports included in the switch 200 by using a predetermined cable. The communication interface 107 performs communication with another device via the switch 200.

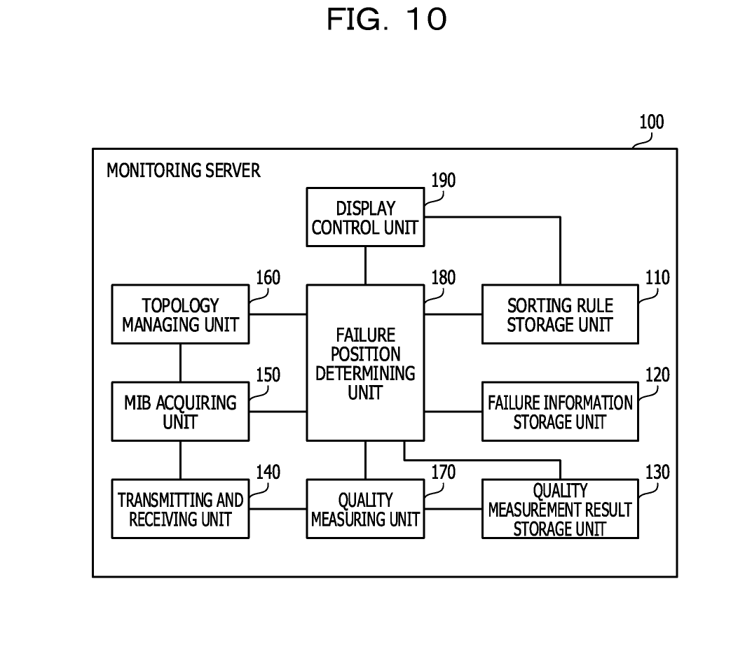

FIG. 10 is a diagram illustrating a function example of the monitoring server according to the third embodiment. The monitoring server 100 includes a sorting rule storage unit 110, a failure information storage unit 120, a quality measurement result storage unit 130, a transmitting and receiving unit 140, a Management Information Base (MIB) acquiring unit 150, a topology managing unit 160, a quality measuring unit 170, a failure section determining unit 180, and a display control unit 190.

The sorting rule storage unit 110, the failure information storage unit 120, and the quality measurement result storage unit 130 may be realized as storage areas secured in the RAM 102 or the HDD 103. The transmitting and receiving unit 140, the MIB acquiring unit 150, the topology managing unit 160, the quality measuring unit 170, the failure section determining unit 180, and the display control unit 190 may be realized by a predetermined program executed by the processor 101.

The sorting rule storage unit 110 stores information on the sorting rule and the change pattern of the sorting rule. The sorting rule is information indicating that hash values calculated from the sets of the source IP addresses and the destination IP addresses included in the packets are sorted to which of the physical links belonging to the LAG between the switches 200a and 200b. The sorting rule includes plural candidates of an initial sorting rule, and an after-restoration sorting rule for the physical links of the LAG which went down by failure, and restored from failure.

The change pattern of the sorting rule is different according to a vendor of a switch. Therefore, the sorting rule storage unit 110 stores candidates of initial setting of the sorting rule and an after-restoration sorting rule according to down/restoration of any one of physical links, by using switches of respective vendors, in advance, in association with vendor identification information. The operator (person using the monitoring server 100, also referred to as a user) of the information processing system may easily set the sorting rule used by the monitoring server 100 for perform monitoring, by inputting vendor identification information to the monitoring server 100.

The failure information storage unit 120 stores failure information. The failure information is information for managing a state in which failure is generated in respective physical links in the switches 200a and 200b. The failure information is updated by the failure section determining unit 180.

The quality measurement result storage unit 130 stores the measuring result of the communication quality in the network, in association with the hash value. The measurement of the communication quality is performed by the quality measuring unit 170.

The transmitting and receiving unit 140 receives packets flowing from a mirror port set by the switch 200 to the network, and stores the packets in the storage area of the RAM 102 or the HDD 103 in association with the received time. The packets collected by the transmitting and receiving unit 140 are used by the quality measurement by the quality measuring unit 170.

In addition, the transmitting and receiving unit 140 performs communication by the switches 200, 200a, 200b, and 200c and simple network management protocol (SNMP) in response to the instruction of the MIB acquiring unit 150. The transmitting and receiving unit 140 collects the MIB information relating to the LLDP from the switches 200, 200a, 200b, and 200c by using SNMP. The MIB information collected by the transmitting and receiving unit 140 is used for acquiring a physical coupling relationship (also referred to as topology) between switches by the topology managing unit 160.

The MIB acquiring unit 150 instructs the transmitting and receiving unit 140 to perform an SNMP communication for collecting the MIB information relating to LLDP. For example, the MIB acquiring unit 150 generates an SNMP request in which a MIB object is designated according to the switch of the monitoring target, and transmits the SNMP request to the transmitting and receiving unit 140 using the switch of the monitoring target as the destination, for collecting the MIB information relating to LLDP. The MIB acquiring unit 150 acquires an SNMP response (MIB information) from the switch according to the SNMP request via the transmitting and receiving unit 140, and stores the SNMP response in the storage area of the RAM 102 or the HDD 103. In addition, the MIB acquiring unit 150 may collect the MIB information relating to CDP, as information for acquiring topology between the switches.

The topology managing unit 160 acquires the topology between the switches based on the MIB information collected by using the transmitting and receiving unit 140 and the MIB acquiring unit 150. Accordingly, the topology managing unit 160 recognizes that one physical link exists between the switches 200 and 200a, four physical links forming LAG exist between the switches 200a and 200b, and one physical link exists between the switches 200b and 200c. The topology managing unit 160 generates information indicating topology between switches, and stores the information in the storage area of the RAM 102 or the HDD 103. The information indicating topology is used for processing of determining a failure section by the failure section determining unit 180.

The quality measuring unit 170 measures the communication quality in the network based on the packets collected by the transmitting and receiving unit 140, and stores measuring results of the communication quality in the quality measurement result storage unit 130. The quality measuring unit 170 monitors whether a packet is lost for each hash value calculated from the set of source IP addresses and the destination IP addresses included in the packets. The quality measuring unit 170 measures whether a packet is lost based on the information set in an identifier (ID) field included in the header of the packet. For example, a device of the transmission source of the packet sequentially transmits packets while incrementing the set value (ID) of the ID field. In this case, when an ID observed in a certain flow is interrupted, the quality measuring unit 170 detects the loss of a packet in the flow. In addition, the quality measuring unit 170 may recognize the number of packets from the number of omitted IDs.

The quality measuring unit 170 determines whether the quality deterioration is generated, according to the packet lost situation. The quality measuring unit 170 determines whether the quality deterioration is generate, according to the comparison of a ratio of the number of lost packets to the number of transmitted and received packets (loss rate of packet) and the threshold value, in the flow associated with a certain hash value. That is, if the loss rate of the packet is equal to or greater than the threshold value (for example, 1%), the quality measuring unit 170 determines that the quality deterioration is generated. Meanwhile, if the loss rate of the packets is less than the threshold value, the quality measuring unit 170 determines that the quality deterioration is not generated, if the loss rate of the packets is less than a threshold value.

The failure section determining unit 180 refers to the quality measuring result by the quality measuring unit 170 and searches a set of hash values which is completely identical to the set of hash values associated with the plural flows in which the quality deterioration is generated, from the sets of the hash values registered in the sorting rule. If the set of hash values may be searched, the failure section determining unit 180 determines that the communication quality is deteriorated, resulting from the physical link associated with the set of hash values in the sorting rule. If the set of hash values is not searched in the sorting rule, the failure section determining unit 180 determines that the cause of the quality deterioration is not the physical link belonging to LAG.

At this point, the failure section determining unit 180 selects, from which sorting rule, a set of hash values is to be searched, based on the registration result of the failure information. That is, if failure information generated in predetermined time in the past is not registered, the failure section determining unit 180 selects the sorting rule which is currently referred. Meanwhile, if failure information generated in predetermined time in the past is registered, the failure section determining unit 180 selects an after-restoration sorting rule according to the failure information. The failure section determining unit 180 detects the possibility of the failure in the physical links based on the collected packets, and records the failure information.

The display control unit 190 controls the display of a graphical user interface (GUI) by the display 51. Specifically, if it is determined that the deterioration of the communication quality is generated in any one of physical links belonging to LAG by the failure section determining unit 180, the display control unit 190 displays that deterioration of the communication quality is generated in the physical link, on the display 51.

In addition, the display control unit 190 causes the display 51 to display GUI for supporting the setting registration of the sorting rule in LAG by the system operator. The display control unit 190 stores the sorting rule input by the operator in the sorting rule storage unit 110. Otherwise, the display control unit 190 may receive the input of the vendor identification information by the system operator. The failure section determining unit 180 selects a sorting rule used for monitoring, from the sorting rules which are already stored in the sorting rule storage unit 110, based on the input vendor identification information, and determines the failure section.

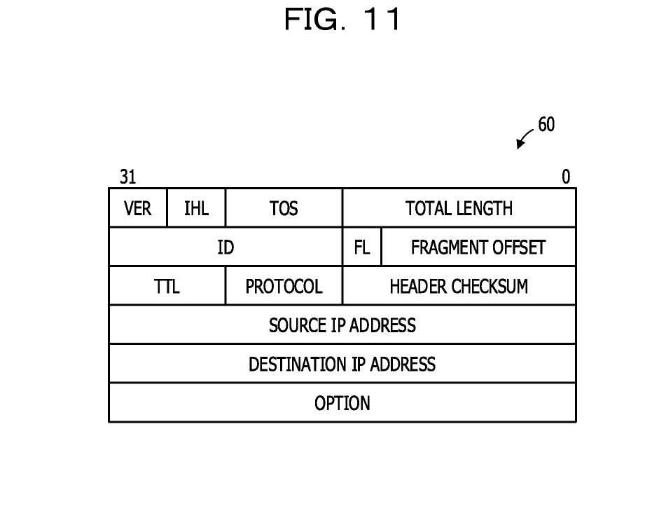

FIG. 11 is a diagram illustrating an example of the IP header according to the third embodiment. An IP header 60 is information of 20 bytes (however, size except for an Option field in variable length). Various fields such as a source IP address or a destination IP address are included in the IP header 60. As described above, a transmission device of a series of packets transmits respective packets to a destination device while incrementing a set value of the ID field.

Therefore, the quality measuring unit 170 may determine whether packet is lost, for each flow, based on the set value of the ID field included in the IP header 60, by checking whether the packets are sequentially transmitted. For example, if the quality measuring unit 170 may observe consecutive IDs from the collected packets without omission, the quality measuring unit 170 may determine that a packet is not lost in the flow. Meanwhile, if the quality measuring unit 170 observes omission of a portion of the consecutive IDs, the quality measuring unit 170 may determine a packet is lost in the flow. The quality measuring unit 170 may acquire the number of lost packets by distinguishing the number of omitted IDs among the consecutive IDs.

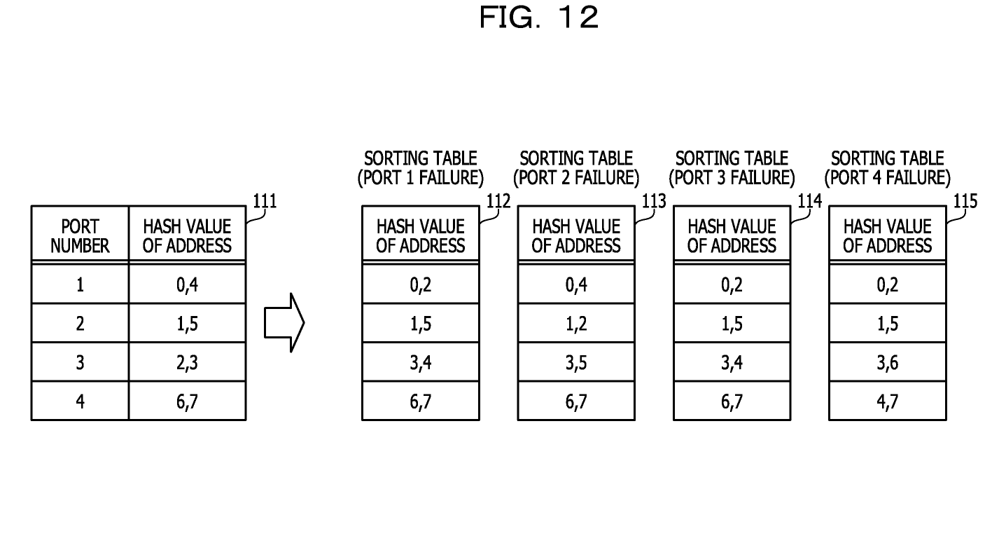

FIG. 12 is a diagram illustrating an example of the sorting table T1 according to the third embodiment. A sorting table 111 indicates that a hash value calculated based on the address included in the packet is sorted to which physical link belonging to LAG between the switches 200a and 200b. In addition, the sorting table 111 is information indicating an initial sorting rule in which the switches 200a and 200b are started to be operated.

The sorting table 111 includes items of port numbers and hash values of the address. Port numbers associated with the physical link are registered to the items of the port numbers. Here, as described above, ports identified by the same port number of the switches 200a and 200b are coupled via a cable to form one physical link. Therefore, one physical link may be identified between the switches 200a and 200b by the port number. The sets of hash values of the address sorted to the physical link are registered in the items of the hash values of the address.

Here, in the example of the third embodiment, the switches 200a and 200b associate the respective flows with 8 hash values of 0 to 7. In the calculation of the hash values associated with the respective flows, for example, predetermined calculation for specific bits included in the source IP address and the destination IP address may be used. The quality measuring unit 170 and the failure section determining unit 180 use the same calculation as the switches 200a and 200b in order to obtain the respective hash values in the respective flow.

For example, information of the port number “1” of hash values “0, 4” of the address is registered to the sorting table 111. This indicates that the set of hash values (0, 4) is sorted to the physical link identified by the port number “1”. The set of hash values is associated with another physical link, in the same manner. Here, the third embodiment indicates an example in which, when four physical links belonging to LAG are all normal, two hash values are sorted for one physical link.

When a sorting rule indicated by the sorting table 111 is applied to LAG, sorting tables 112, 113, 114, and 115 are candidates of the after-restoration sorting rules when any one of physical links went down, and restored thereafter. The sorting tables 112, 113, 114, and 115 may be candidates of sorting rules after restoration from link failure.

The sorting table 112 indicates an after-restoration sorting rule when failure was generated in the physical link indicated by the port number “1”, and restored from the failure. The sorting table 113 indicates an after-restoration sorting rule when failure was generated in the physical link indicated by the port number “2” and restored from the failure. The sorting table 114 indicates an after-restoration sorting rule, when failure was generated in the physical link indicated by the port number “3” and restored from the failure. The sorting table 115 indicates an after-restoration sorting rule, when failure was generated in the physical link indicated by the port number “4” and restored from the failure.

The sorting tables 112, 113, 114, and 115 also indicate correlation between the hash values of the address and the port number of the sorting destination, in the same manner as in the sorting table 111. However, in FIG. 12, items of port numbers in the sorting tables 112, 113, 114, and 115 are not illustrated. Four records included in the respective sorting tables 112, 113, 114, and 115 may be associated with the respective port numbers “1”, “2”, “3”, and “4” in an ascending order.

By using the sorting tables 112, 113, 114, and 115, as starting points, plural candidates of the after-restoration sorting tables when physical link failure/restoration was generated may be further registered to the sorting rule storage unit 110.

The change pattern of the sorting rule in LAG varies according to the vendor of the switch. The system operator may register the sorting rules and the change patterns to the sorting rule storage unit 110 in advance, in association with the vendor identification information, by using GUI described below. The information of the change pattern from the sorting tables 111, 112, 113, 114, and 115 and the sorting table 111 to the sorting tables 112, 113, 114, and 115 is registered, for example, to the sorting rule storage unit 110 associated with the vendor identification information “A”. In addition, the sorting rule registered in advance may be easily brought up by designating the vendor identification information registered in advance.

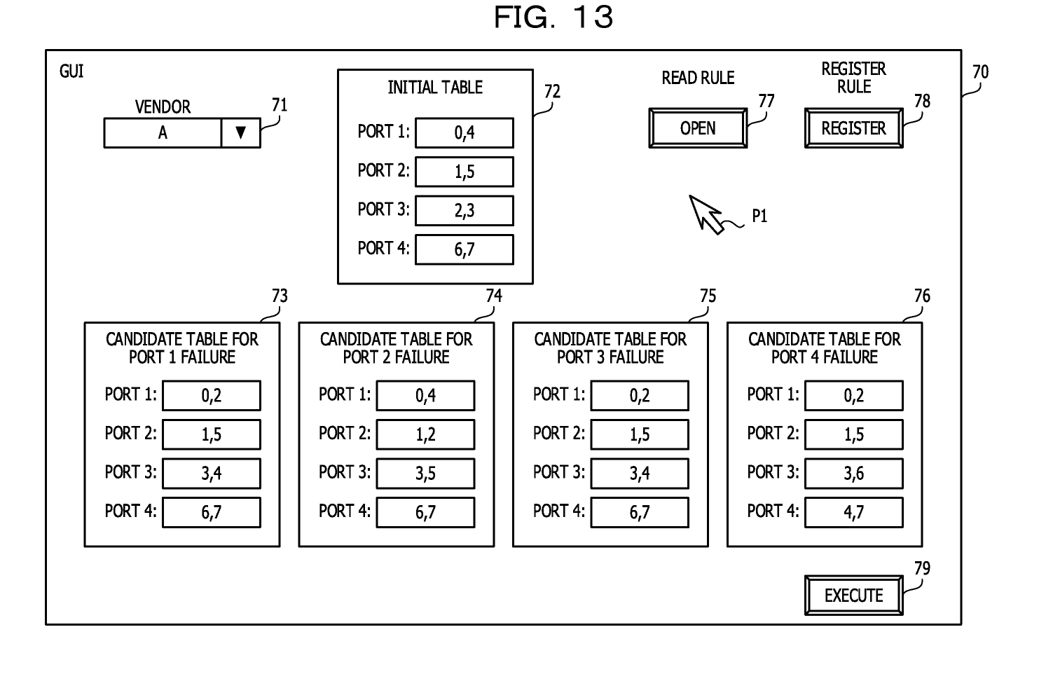

FIG. 13 is a diagram illustrating an example of the GUI according to the third embodiment. A GUI 70 is generated by the display control unit 190 and displayed by the display 51. The GUI 70 includes a vendor selecting form 71, input forms 72, 73, 74, 75, and 76 and buttons 77, 78, and 79. The operator may read the GUI 70, move a pointer P1 displayed on the GUI 70 by operating the input device 52, and select an input form desired to be set or press a button. In addition, the operator may input the set value to the selected input form.

The vendor selecting form 71 is a pull down form for selecting registered vendor identification information. If the vendor selecting form 71 is selected by the pointer P1, the display control unit 190 may display a list of the registered vendor identification information and causes any vendor to be select by the pointer P1. The display control unit 190 acquires sorting rules according to the selected vendor identification information from the sorting rule storage unit 110, and causes the sorting rules to be displayed on text boxes of the input forms 72, 73, 74, 75, and 76. In the example of FIG. 13, the vendor identification information “A” is selected.

An input form 72 is a form for inputting an initial value of the sorting rule. Four text boxes associated with the port numbers (that is, physical links) are displayed on the input form 72. For example, if the vendor identification information “A” is selected in the vendor selecting form 71, setting contents of the sorting table 111 are displayed in the respective text boxes of the input form 72. Here, four text boxes associated with the port numbers are also displayed on the input forms 73, 74, 75, and 76.

The input form 73 is a form for inputting the after-restoration sorting rule when failure was generated in the physical link of the port number “1” and restored from the failure. For example, if the vendor identification information “A” is selected in the vendor selecting form 71, the setting contents of the sorting table 112 are displayed in the respective text boxes of the input form 73.

The input form 74 is a form for inputting an after-restoration sorting rule when failure was generated in a physical link of the port number “2” and restored from the failure. For example, if the vendor identification information “A” is selected in the vendor selecting form 71, the setting contents of the sorting table 113 are displayed on the respective text boxes of the input form 74.

The input form 75 is a form for inputting an after-restoration sorting rule when failure was generated in a physical link of the port number “3” and restored from the failure. For example, if the vendor identification information “A” is selected in the vendor selecting form 71, the setting contents of the sorting table 114 are displayed on the respective text boxes of the input form 75.

The input form 76 is a form for inputting an after-restoration sorting rule when failure was generated in a physical link of the port number “4” and restored from the failure. For example, if the vendor identification information “A” is selected in the vendor selecting form 71, the setting contents of the sorting table 115 are displayed on the respective text boxes of the input form 76.

The operator may select text boxes included in the input forms 72, 73, 74, 75, and 76 by the pointer P1 and change the set values displayed on the respective text boxes.

The button 77 is a button to be pressed when a sorting rule to be newly registered is read. If the button 77 is pressed, the display control unit 190 causes a dialogue for causing the user to select the data (rule registration data) for registering the sorting rule to be displayed on the display 51. The display control unit 190 causes contents of the sorting rule described in the selected rule registration data, to be displayed on the GUI 70. The display control unit 190 changes the number of text boxes to be displayed in the input forms 72, 73, 74, 75, and 76, depending on the number of physical links belonging to LAG.

The button 78 is a button to be pressed when the sorting rule displayed on the GUI 70 is registered to the sorting rule storage unit 110. If the button 78 is pressed, the display control unit 190 stores input contents (that is, sorting rule and change pattern) of the input forms 72, 73, 74, 75, and 76 in association with the vendor identification information to the GUI 70, in the sorting rule storage unit 110.

The button 79 is a button to be pressed when the monitoring server 100 is caused to start monitoring of the network using input setting contents input to the GUI 70. For example, the display control unit 190 causes the failure section determining unit 180 to start network monitoring used in the sorting rule indicated in the GUI 70.

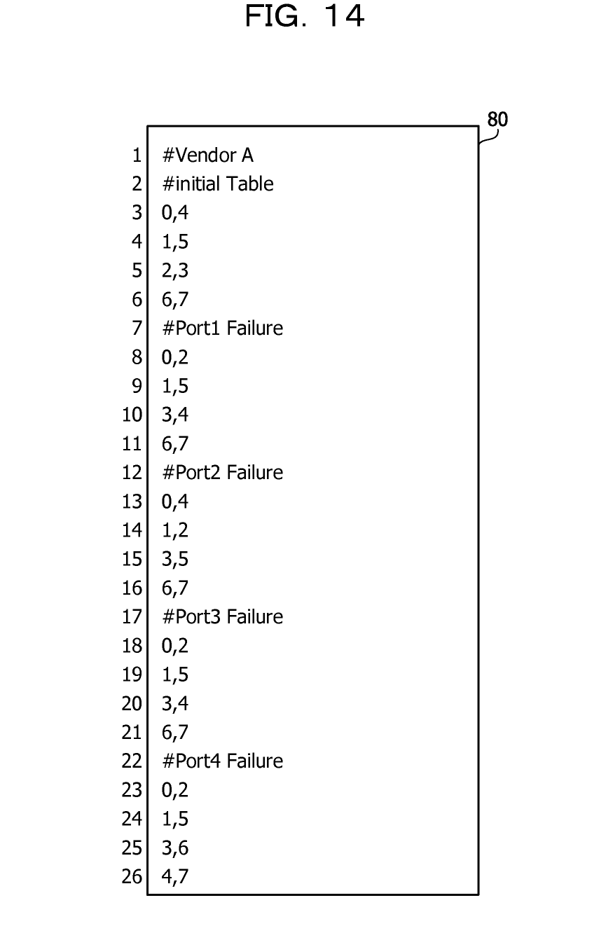

FIG. 14 is a diagram illustrating an example of the rule registration data according to the third embodiment. Rule registration data 80 is an example of data for registering the sorting rules illustrated in FIGS. 12 and 13 to the sorting rule storage unit 110. If the button 77 is pressed and the rule registration data 80 is selected in the GUI 70, the display control unit 190 causes the contents of the rule registration data 80 to be displayed on the GUI 70.

The rule registration data 80 may be stored in the HDD 103, in advance (for example, may be received from vendor of switch). Otherwise, the operator may test operations using the switches 200a and 200b, create the rule registration data 80 in advance, and store the rule registration data 80 in the HDD 103 or the like. In FIG. 14, the numbers (numbers of 1 to 26) on the left of the rule registration data 80 are column numbers given for convenience.

On the first row, there is information of “#Vendor A”. This indicates that the following information is information to be associated with the vendor identification information “A”.

On the second row, there is information of “#initial Table”. This indicates that the following information is a sorting rule when the system is started to be operated. On the third to sixth rows, there is information indicating the set of hash values “0, 4”, “1, 5”, “2, 3”, and “6, 7”.

On the seventh row, there is information of “#Port1 Failure”. This indicates that the following information is a sorting rule when failure was generated in the physical link in the port number “1”, and the physical link is restored from the failure. In this case, the display control unit 190 distinguishes a sorting rule when the system is operated to the third to sixth rows. On the four rows of the third to sixth rows, four sets of the hash values are set. The display control unit 190 may associate the set of hash values with the physical link of the port number “1”, the physical link of the port number “2”, and the like, in an ascending order. In the same manner, the after-restoration sorting rule according to the failure in the physical link of the port number “1” is indicated by the information on the eighth to eleventh rows.

In the same manner, on the twelfth row, there is information of “#Port2 Failure”. This indicates that the following information (up to sixteenth row right before “#Port3 Failure” on the seventeenth row) is a sorting rule after failure was generated in the physical link of the port number “2”, and the physical link is restored from the failure. The after-restoration sorting rules after restoration from failure of respective physical links of the port numbers “3” and “4” are described in the same manner.

In addition, after the twenty sixth row of the rule registration data, sorting rules relating to another vendor may be described. For example, if there is information on “#Vendor B” on the twenty seventh row, the display control unit 190 may distinguish that the information after the twenty eighth row is not information associated with the vendor identification information “A”, but information associated with the vendor identification information “B”. Further, the information on sorting rules and change patterns of the sorting rules may be registered to the sorting rule storage unit 110 by a format of the rule registration data 80.

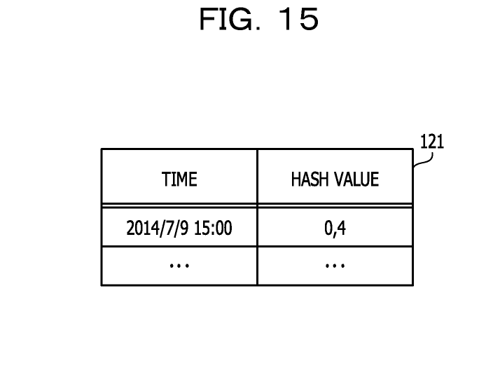

FIG. 15 is a diagram illustrating an example of a failure management table according to the third embodiment. A failure management table 121 is stored in the failure information storage unit 120. The failure management table 121 stores a table for managing the set of hash values of which observation is interrupted for a period of a certain length among the sets of the hash values registered in the current sorting rules. The interruption of the observation of the hash value means that the transmission of packets is interrupted in the flow associated with the hash values of which observation is interrupted. The failure management table 121 includes items of time and hash values.

Time when it is detected that observation of a set of certain hash values is interrupted for a period of a certain length is registered to the item of time. A set of hash values is registered to the item of the hash value. For example, information that time is “Jul. 7, 2009 15:00”, and a hash value is “0, 4” is registered to the failure management table 121. This indicates that the observation of the hash values “0” and “4” are interrupted for a period of a certain length, and the interruption is observed at 15:00 on Jul. 9, 2014.

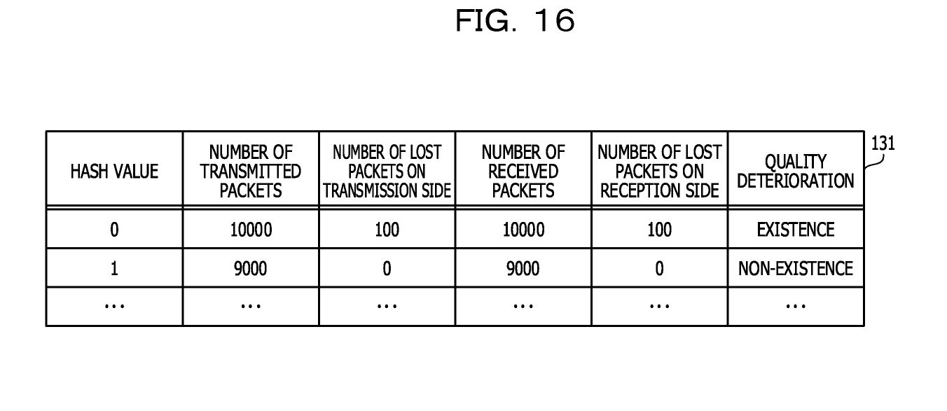

FIG. 16 is a diagram illustrating a quality measurement result table according to the third embodiment. The quality measurement result table 131 is generated by the quality measuring unit 170, and stored in the quality measurement result storage unit 130. The quality measurement result table 131 is information for managing packet lost situation and existence of quality deterioration for the hash values calculated from the address of the packet. A quality measurement result table 131 includes items of hash values, the number of transmitted packets, the number of lost packets on the transmission side, the number of received packets, the number of lost packets on the reception side, and quality deterioration.

Hash values are registered in the item of the hash value. The number of packets transmitted from the clients 300, 300a, and 300b to the servers 400, 400a, and 400b are registered to the number of transmitted packets. The number of lost packets among the packets transmitted from the clients 300, 300a, and 300b to the servers 400, 400a, and 400b is registered to the item of the number of lost packets on the transmission side. The number of packets transmitted from the servers 400, 400a, and 400b to the clients 300, 300a, and 300b is registered to the item of the number of received packets. The number of lost packets among the packets transmitted from the servers 400, 400a, and 400b to the clients 300, 300a, and 300b is registered to the item of the number of lost packets on the reception side. Information indicating whether quality deterioration exists in the flow associated with the hash value is registered to the item of the quality deterioration.

For example, information of the hash value “0”, the number of transmitted packets “10,000”, the number of lost packets on the transmission side “100”, the number of received packets “10,000”, the number of lost packets on the reception side “100”, and “existence” of quality deterioration is registered to the quality measurement result table 131.

This indicates that, in the flow associated with the hash value “0”, the number of transmitted packets is 10,000, the number of lost packets among the number of transmitted packets is 100, the number of received packets is 10,000, and the number of lost packets among the number of received packets is 100. In addition, in the flow associated with the hash value “0”, the information indicates that communication quality is deteriorated. For the other hash values, information is registered in the same manner.

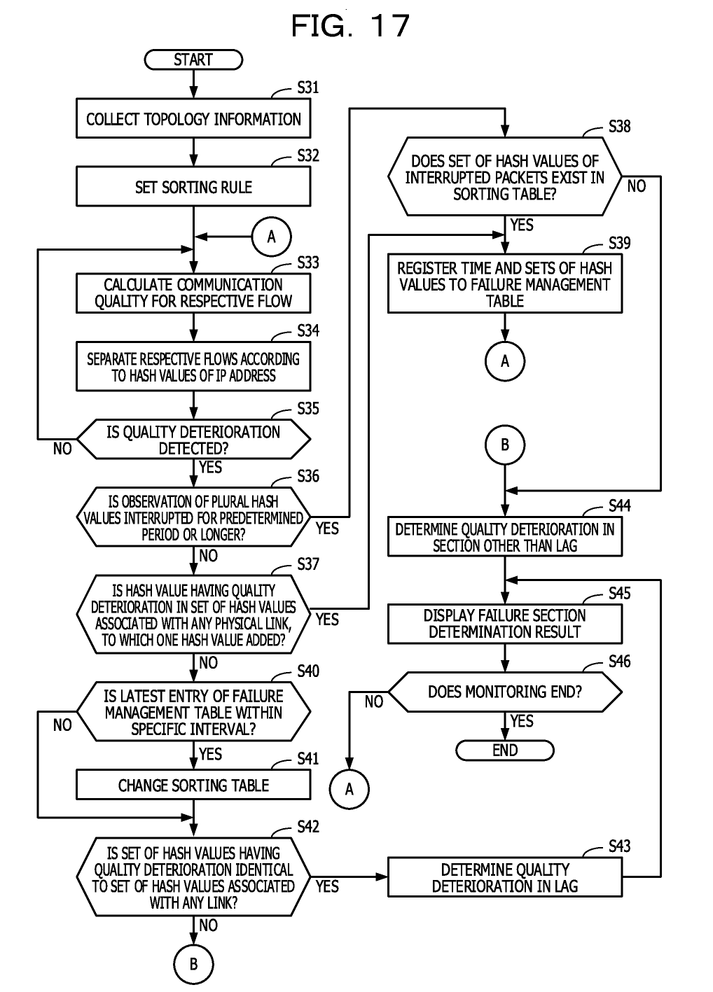

FIG. 17 is a flow indicating a monitoring example according to the third embodiment. Hereinafter, the process indicated in FIG. 17 is described according to the step numbers.

(S31) The topology managing unit 160 collects topology information. Specifically, the topology managing unit 160 instructs the MIB acquiring unit 150 to transmit SNMP requests for collecting topology information. The MIB acquiring unit 150 generates the SNMP requests having respective switches as destinations and transmits the SNMP requests to the transmitting and receiving unit 140. The MIB acquiring unit 150 acquires the SNMP responses (including topology information by LLDP) to the respective switches via the transmitting and receiving unit 140. The topology managing unit 160 acquires information on the physical links between switches from the SNMP responses acquired by the MIB acquiring unit 150.

(S32) The display control unit 190 receives an input of the vendor identification information by the user in the GUI 70. The display control unit 190 refers to the sorting rule storage unit 110 and reflects the sorting rule associated with the selected vendor identification information to the display contents of the GUI 70. For example, if the vendor identification information “A” is selected in the vendor selecting form 71, the GUI 70 becomes display contents illustrated in FIG. 13. If the button 79 is pressed in the GUI 70, the display control unit 190 sets the sorting rule input to the GUI 70 as the sorting rule used by the failure section determining unit 180. For example, the sorting rule associated with the vendor identification information “A” includes the initial sorting table 111 and the after-restoration sorting tables 112, 113, 114, and 115 according to the failure the physical links. The failure section determining unit 180 performs monitoring by using the sorting table 111 at an initial stage of the monitoring.

(S33) The quality measuring unit 170 collects packets from the switch 200 via the transmitting and receiving unit 140. The length of the packet collection period is, for example, about one minute. The quality measuring unit 170 initiates the measurement of the communication quality in the respective flows based on the collected packets. The quality measuring unit 170 acquires the number of transmitted and received packets and the number of lost packets for each flow.

(S34) The quality measuring unit 170 calculates hash values corresponding to the sets of source IP addresses and the destination IP addresses of the respective packets, and separates the respective flows with the calculated hash values. For example, among the plural flows, a portion of the flows is associated with the hash value “0”, and another portion of the flows is associated with the hash value “1”. In this manner, the respective flows may be associated with any hash values. The quality measuring unit 170 acquires the existence of the quality deterioration for the respective hash values, based on the ratio of the number of lost packets (loss rate of packets) to the number of transmitted and received packets for each hash value. If the loss rate of the packets is, for example, 1% or greater, the quality measuring unit 170 determines that quality deterioration “exists”. If the loss rate of the packet is, for example, less than 1%, quality measuring unit 170 determines that quality deterioration “does not exist”. The quality measuring unit 170 registers the number of transmitted and received packets, the number of lost packets, and “existence” and “non-existence” of quality deterioration to the quality measurement result table 131 stored in the quality measurement result storage unit 130 in association with the hash values. Also, the measurement of the communication quality by the quality measuring unit 170 ends.

(S35) The failure section determining unit 180 refers to the quality measurement result table 131, and determines whether the quality deterioration is detected in any hash values. If the quality deterioration is detected, the process proceeds to S36. If the quality deterioration is not detected, the process proceeds to S33. Here, if “existence” is set in the item of the quality deterioration for any of the hash values registered in the quality measurement result table 131, the failure section determining unit 180 determines that quality deterioration is detected. Meanwhile, if “non-existence” is set in the item of the quality deterioration for all hash values, the failure section determining unit 180 determines that quality deterioration is not detected.

(S36) The failure section determining unit 180 refers to the packets collected in S33, and sequentially acquires observation states of the hash values for the hash values in which quality deterioration “exists”. The failure section determining unit 180 determines whether the observation of the plural hash values is interrupted for a period of the length t or longer. If the observation of the plural hash values is interrupted for a period of the length t or longer, the process proceeds to S38. If the observation of the plural hash values is not interrupted for a period of the length t or longer, the process proceeds to S37. The length t is, for example, one to several seconds. The length t is decided in response to the waiting time when the switches 200a and 200b desire to change the storage of the hash values associated with a certain physical link is changed to another physical link. The waiting time is a length according to a vendor of the switches, the kind of the switches, or the like. The length t may be the same length as the waiting period. However, the length t may be the length different from the waiting period (for example, a length shorter than waiting period in a certain rate). In addition, if the number of hash values in which quality deterioration “exists” is 1, the process proceeds to S37.

(S37) The failure section determining unit 180 refers to a currently applied sorting table (the sorting table 111, if the sorting table is not changed from the initial one), and determines whether the hash value in which quality deterioration exists is in a set of hash values associated with any one of physical links of LAG to which one hash value is added. If the hash value in which quality deterioration exists is in a set of hash values associated with any one of physical links of LAG to which one hash value is added, the process proceeds to S39. If the hash value in which quality deterioration exists is not in a set of hash values associated with any one of physical links of LAG to which one hash value is added, the process proceeds to S40. For example, it is assumed that monitoring is performed by using the sorting table 111, and a certain hash value in which quality deterioration exists is in a set of (2, 3, 4). A set of hash values (2, 3) is registered for the physical link of the port number “3” to the sorting table 111. In this case, the set of hash values (2, 3, 4) in which quality deterioration exists may be determined that one hash value “4” is added to the set of hash values (2, 3). In addition, in the sorting rule, since plural hash values are associated with one physical link, if there is one hash value in which quality deterioration exists, the process proceeds to S40.

(S38) The failure section determining unit 180 determines whether a set which is the same as the set of hash values of the packet which is interrupted for the period of the length t or longer is stored in the sorting table. If the same set is stored, the process proceeds to S39. If the same set is not stored, the process proceeds to S44. For example, in S36, observation is interrupted in the set of hash values (0, 4), and if the currently applied sorting table is the sorting table 111, the set of hash values (0, 4) is stored in the sorting table 111.

(S39) The failure section determining unit 180 registers current time and the set of hash values to the failure management table 121 stored in the failure information storage unit 120. Here, the failure section determining unit 180 decides the set of hash values registered as follows. The process (1) described below is performed after S38 (Yes). The process (2) described below is performed after S37 (Yes).

(1) If the set of hash values of which observation is interrupted for a period of the length t or longer is completely identical to any one of the sets of the hash values in the currently applied sorting table, it is determined that the physical link associated with the set of hash values has failure. The failure section determining unit 180 registers the set of hash values to the failure management table 121. The interruption in this case may be determined as a phenomenon at the time of the link-down.

(2) Among the hash value having quality deterioration, the failure section determining unit 180 acquires the hash value (hash value “4” in S37) except for the set of hash values (set of hash values “2, 3” in S37) on the sorting table specified in S37. The failure section determining unit 180 determines from which physical link, the storage of the acquired hash value “4” is changed, based on the sorting table. For example, if the currently applied table is the sorting table 111, the hash value “4” is associated with the physical link of the port number “1”. Accordingly, the failure section determining unit 180 may determine that the physical link of the port number “1” has failure. In this case, the failure section determining unit 180 registers the set of hash values (0, 4) associated with the port number “1” of the sorting table 111 to the failure management table 121. If any one of the processes (1) and (2) is performed, the failure section determining unit 180 proceeds to S33.

(S40) The failure section determining unit 180 determines whether the latest entry of the failure management table 121 is registered within a specific time interval in the past from the present moment. The specific time interval may be decided according to an operation. For example, the specific time interval is set to be one hour if physical link failure is automatically restored within one hour in many cases. If the specific time interval is set to be one hour, the failure section determining unit 180 determines whether the latest entry is registered within one hour. If the latest entry is registered within a specific time interval in the past from the present moment, the process proceeds to S41. If the latest entry is not registered within a specific time interval, the process proceeds to S42. The determination of S40 may be determination on whether the latest entry of the failure management table 121 is relatively new information. If too old entries are ignored, the possibility in which the sorting table is erroneously changed may be reduced.

(S41) The failure section determining unit 180 changes the sorting table used for monitoring, based on the latest entry of the failure management table 121. For example, if the sorting table 111 is used, and the set of hash values registered to the latest entry of the failure management table 121 is (0, 4), the sorting table is changed to the sorting table 112 according to the change pattern illustrated in FIG. 12. Accordingly, the failure section determining unit 180 selects the sorting table 112 as the after-restoration sorting table, and changes the sorting table used for monitoring to the sorting table 112.

(S42) The failure section determining unit 180 determines whether the set of hash values having quality deterioration is completely identical to the set of hash values associated with any one of the physical links registered to the currently applied sorting table. If the set of hash values having quality deterioration is completely identical, the process proceeds to S43. If not, the process proceeds to S44.

(S43) The failure section determining unit 180 determines that the quality deterioration detected in S35 is quality deterioration in LAG. The failure section determining unit 180 acquires the physical link associated with the set of hash values having quality deterioration from the currently applied sorting table. Then, the process proceeds to S45.

(S44) The failure section determining unit 180 determines that the quality deterioration detected in S35 is quality deterioration in a section other than LAG.

(S45) The display control unit 190 causes the display 51 to display the determination result of the failure section determined by the failure section determining unit 180. For example, if it is determined that the quality deterioration is the quality deterioration in LAG, the display control unit 190 causes the display 51 to display the fact that the quality deterioration is generated in LAG and the information (for example, port number) of the physical link. In addition, if the quality deterioration is the quality deterioration in a section other than LAG, the display control unit 190 causes the display 51 to display the fact that the quality deterioration is generated in a section other than LAG.

(S46) The failure section determining unit 180 determines whether to end monitoring. If it is determined to end monitoring, the process ends. If it is determined not to end monitoring, the process proceeds to S33. For example, the failure section determining unit 180 may cause a certain period after the sorting rule is set in S32, to be a monitoring period, and determine to end the monitoring if the monitoring period expires. Otherwise, the failure section determining unit 180 may determine that the monitoring ends when an operation input of ending monitoring is received by the operator.

Here, in S37, the reason of determining whether the hash value having quality deterioration is in any one of the sets of the hash values registered to the sorting table, to which one hash value is added is to suppress the decrease of the determination precision of the physical link failure. That is, if the hash value having the quality deterioration in any one of the sets of the hash values registered to the sorting table, to which plural hash values are added, it is not likely that the physical link failure is generated.

In addition, in S36, the failure section determining unit 180 may determine whether the observation of a certain hash value is interrupted with focus on the source IP address in each flow. Specifically, if the monitoring server 100 is coupled to the switch 200, hash values may be observed only for packets having IP addresses of the servers 400, 400a, and 400b as source IP addresses. This is because down of the physical links in LAG in the packet collection has stronger influence on the packets transmitted from the server side, than those from the client side. In addition, the failure section determining unit 180 may check whether the collection of packets is interrupted for a period of the certain length t or longer, in a flow unit and determine that the observation of the hash value is interrupted for the period, if the interruption exists in any one of flows associated with a certain hash value.

In addition, as described above, it is recognized that quality deterioration is generated in a specific physical link which is currently operated in the case of S37 (Yes). Therefore, the display control unit 190 may cause the display 51 to display, for example, the fact that the quality deterioration is generated in the physical link, so as to notify the fact to the operator.

Further, in S38, the failure section determining unit 180 may determine whether the interrupted set of hash values exists in any one of the currently applied sorting table and the after-restoration sorting tables. Also, if the set of hash values exists in any one of the current or after-restoration sorting tables, the determination in S38 may be “Yes” (“No” in the other cases). More specifically, the currently applied sorting table is the sorting table 111, and the after-restoration sorting tables are the sorting tables 112, 113, 114, and 115. In S36, if the observation is interrupted in the set of hash values (0, 4), the set of hash values (0, 4) is stored in the sorting table 111 (first case). Meanwhile, in S36, if the observation is interrupted in the set of hash values (0, 2), the set of hash values (0, 2) is not stored in the sorting table 111, but is stored in the after-restoration sorting table 112 (second case). In the second case, the process in S39 (1) is different from the first case. In the second case, the failure section determining unit 180 performs the following process.

If the set of hash values of which observation is interrupted for a period of the length t or longer does not exist in the currently applied sorting table but exists in the after-restoration sorting table, the interruption may be determined to be a phenomenon at the time of the link restoration. In this case, the failure section determining unit 180 searches the sets of the hash values of which observation is interrupted in the after-restoration sorting table, and determines in which physical link, failure exists. For example, a case in which monitoring is performed by using the sorting table 111 is considered. The failure section determining unit 180 may not determine a physical link having failure from the sorting table 111, if the set of hash values of which observation is interrupted is (0, 2). Therefore, the failure section determining unit 180 refers to the after-restoration sorting tables 112, 113, 114, and 115 and searches the set of hash values (0, 2). In the sorting tables 112, 114, and 115, the set of hash values (0, 2) is associated with the physical link of the port number “1”. Therefore, the failure section determining unit 180 determines the physical link of the port number “1” has failure. Also, the failure section determining unit 180 registers the set of hash values (0, 4) associated with the port number “1” of the sorting table 111 to the failure management table 121. The following is the same as the following steps illustrated in FIG. 17.

Subsequently, relationships of the state of LAG between the switches 200a and 200b with the sorting rules used by the monitoring server 100 for monitoring and the contents of the failure management table 121 are described. In the examples described below, in the monitoring server 100, the sorting rule associated with the vendor identification information “A” is set for monitoring, so at the time point of the initial steps in the respective examples, the sorting table 111 is used. In addition, in the drawings, switches are simply denoted by “Switch (SW)”.

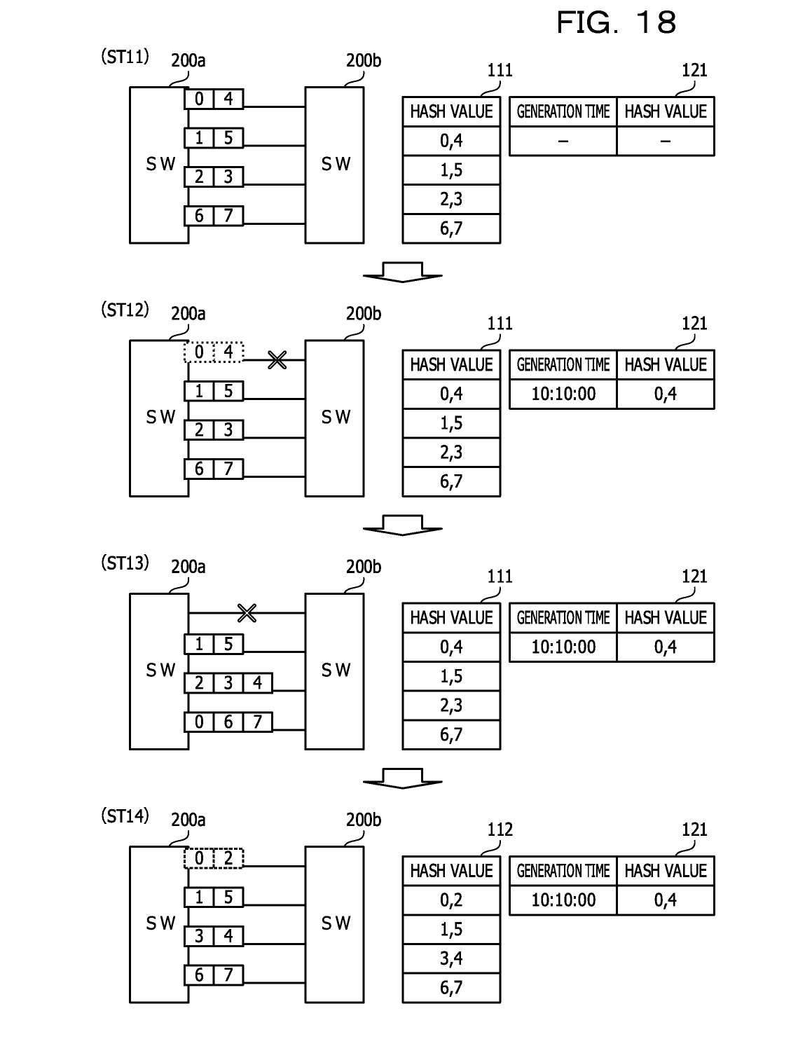

FIG. 18 is a (first) monitoring example according to the third embodiment. Herein, the processes illustrated in FIG. 18 are described according to step numbers.

(ST11) At this point, all physical links of LAG are normal. The switches 200a and 200b sort the hash values to the physical links in the same rule as in the sorting table 111. At this point, there is no entry of the failure management table 121.

(ST12) The physical link of the port number “1” goes down by failure. The monitoring server 100 detects the observation of the hash values “0” and “4” is interrupted for a period of a predetermined length (for example, about 1 to several seconds). This is because, before the storage of the hash values “0” and “4” is changed to another normal physical link, if the transmission of the packets associated with the hash values “0” and “4” by the switches 200a and 200b is temporarily stopped. Then, the monitoring server 100 registers the set of hash values (0, 4) to the failure management table 121 in association with current time (example of (1) illustrated in S39 of FIG. 17).

(ST13) The physical link of the port number “1” is currently being down. The switches 200a and 200b transmit the hash value “4” in association with the physical link of the port number “3” and the hash value “0” in association with the physical link of the port number “4”.

(ST14) The link-down of the physical link of the port number “1” is restored. The switches 200a and 200b sort the set of hash values (0, 2) to the physical link of the port number “1” (becomes the same rule as the sorting table 112). Also, the monitoring server 100 detects the quality deterioration in the flow associated with the hash values “0” and “2” (there is no interruption in the same period as the observation of hash values for the respective flows). The monitoring server 100 checks that the set of hash values (0, 4) is registered to the failure management table 121, and the registration time is within a specific time in the past from the present moment (for example, within one hour).

Then, the monitoring server 100 switches the currently referred sorting table 111 to the after-restoration sorting table 112 of the physical link (associated with set of hash values (0, 4)) of the port number “1” based on the information of the change pattern. Also, the monitoring server 100 determines that the quality deterioration is caused by the physical link of LAG by using the sorting table 112. The set of hash values (0, 2) is registered to the sorting table 112 in association with the physical link of the port number “1”. Therefore, the monitoring server 100 determines the generation of the quality deterioration is caused by the physical link of the port number “1”. The monitoring server 100 notifies the quality deterioration section to the operator by displaying the determination result to the display 51.

In this manner, the monitoring server 100 may determine the change of the sorting rule by detecting that the set of hash values when the link-down is generated is not able to be observed for a period of a predetermined length. However, in ST12, the packets may not flow through the physical links which went down. If the packets do not flow through the physical links which went down, the monitoring server 100 overlooks the change of the sorting rules. Therefore, the monitoring server 100 performs monitoring as described below.

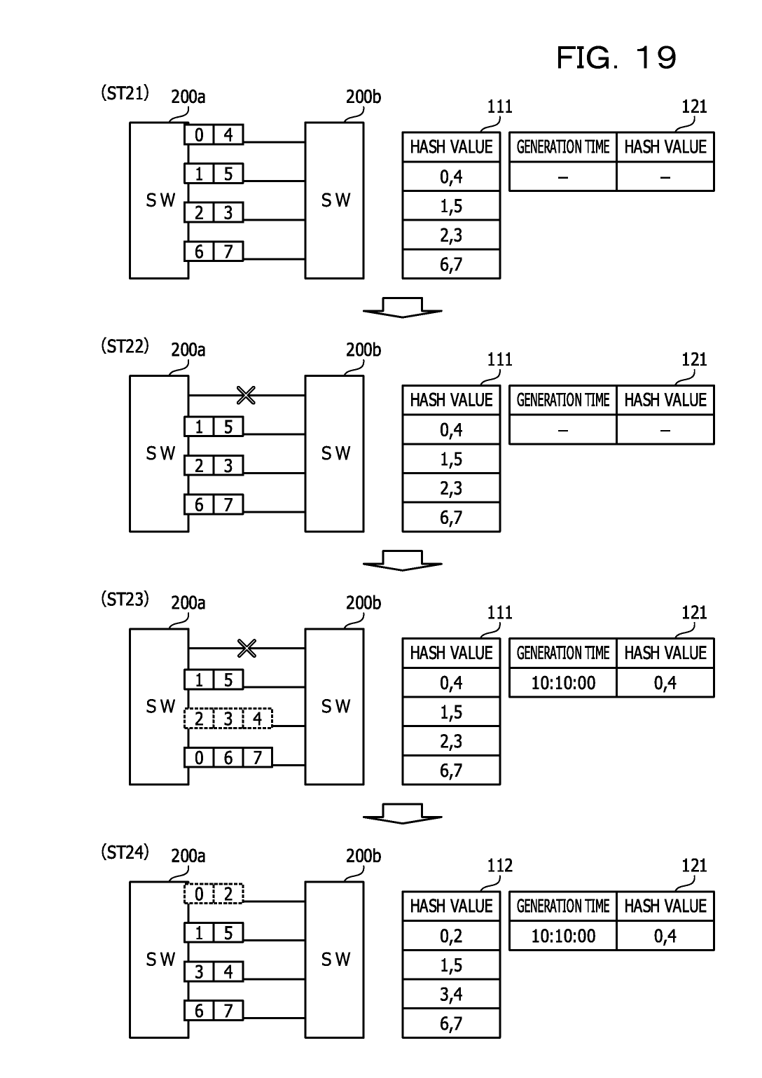

FIG. 19 is a (second) monitoring example according to the third embodiment. Herein, the processes illustrated in FIG. 19 are described according to step numbers.

(ST21) At this point, all physical links of LAG are normal. The switches 200a and 200b sort the hash values to the physical links in the same rule as in the sorting table 111. At this point, there is no entry of the failure management table 121.

(ST22) The physical link of the port number “1” goes down by failure. However, since packets do not flow through the physical link of the port number “1”, the monitoring server 100 observes nothing. At this point, there is still no entry of the failure management table 121.

(ST23) The physical link of the port number “1” is currently being down. The switches 200a and 200b transmits the hash value “4” in association with the physical link of the port number “3” and the hash value “0” in association with the physical link of the port number “4”. In this state, the monitoring server 100 detects the quality deterioration of the flow associated with the hash values “2”, “3”, and “4” (there is no interruption in the same period of observation of hash values for respective periods). Then, the monitoring server 100 determines that, in addition to the set of hash values (2, 3) sorted in the normal state, the storage of the hash value “4” is changed, based on the sorting table 111.

Further, according to the sorting table 111, in the normal state, when the hash value “4” is associated with the same physical link as the hash value “0” (port number “1”). Therefore, the monitoring server 100 determines that the link-down was generated in the physical link of the port number “1”, and registers the hash values “0, 4” to the failure management table 121 together with the current time (example of (2) illustrated in S39 of FIG. 17).

(ST24) The link-down of the physical link of the port number “1” is restored. The switches 200a and 200b sort the set of hash values (0, 2) to the physical link of the port number “1” (in the same rule as the sorting table 112). Also, the monitoring server 100 detects the quality deterioration in the flow associated with the hash values “0” and “2” (there is no interruption in the same period as the observation of hash values for the respective flows). The monitoring server 100 checks that the set of hash values (0, 4) is registered to the failure management table 121, and the registration time is within a specific time in the past from the present moment (for example, within one hour).

Then, the monitoring server 100 switches the currently referred sorting table 111 to the after-restoration sorting table 112 of the physical link (associated with set of hash values (0, 4)) of the port number “1”. Also, the monitoring server 100 determines that the quality deterioration is caused by the physical link of LAG by using the sorting table 112. The set of hash values (0, 2) is registered to the sorting table 112 in association with the physical link of the port number “1”. Therefore, the monitoring server 100 determines the generation of the quality deterioration is caused by the physical link of the port number “1”. The monitoring server 100 notifies the quality deterioration section to the operator by displaying the determination result to the display 51.

In this manner, even if interruption of the set of hash values is not detecting when the link-down is generated, the monitoring server 100 may determine the change of the sorting rule based on the hash values in which quality deterioration is observed during the link-down. However, even if the quality deterioration is not observed during link-down, the change of the sorting rule may be overlooked. Therefore, the monitoring server 100 further performs the following monitoring.

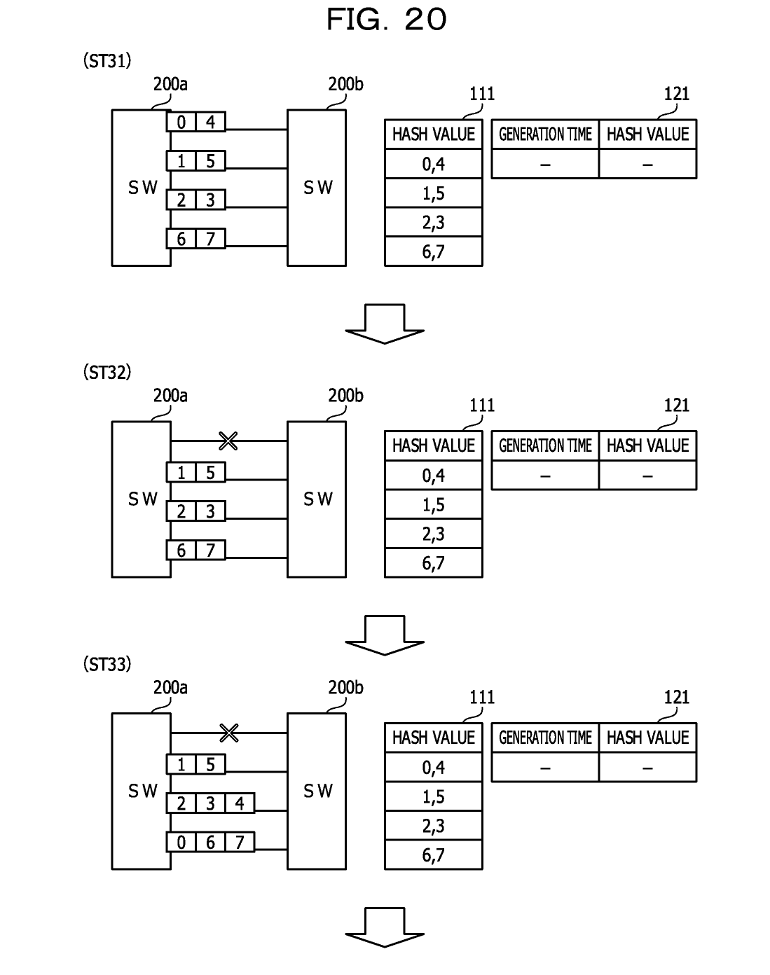

FIG. 20 is a (third) monitoring example according to the third embodiment. Herein, the processes illustrated in FIG. 20 are described according to step numbers.

(ST31) At this point, all physical links of LAG are normal. The switches 200a and 200b sort the hash values to the physical links in the same rule as in the sorting table 111. At this point, there is no entry of the failure management table 121.

(ST32) The physical link of the port number “1” goes down by failure. However, since packets do not flow through the physical link of the port number “1”, the monitoring server 100 observes nothing. At this point, there is still no entry of the failure management table 121.

(ST33) The physical link of the port number “1” is currently being down. The switches 200a and 200b transmits the hash value “4” in association with the physical link of the port number “3” and the hash value “0” in association with the physical link of the port number “4”. Since communication is normally performed with three physical links, the monitoring server 100 does not observe the quality deterioration.

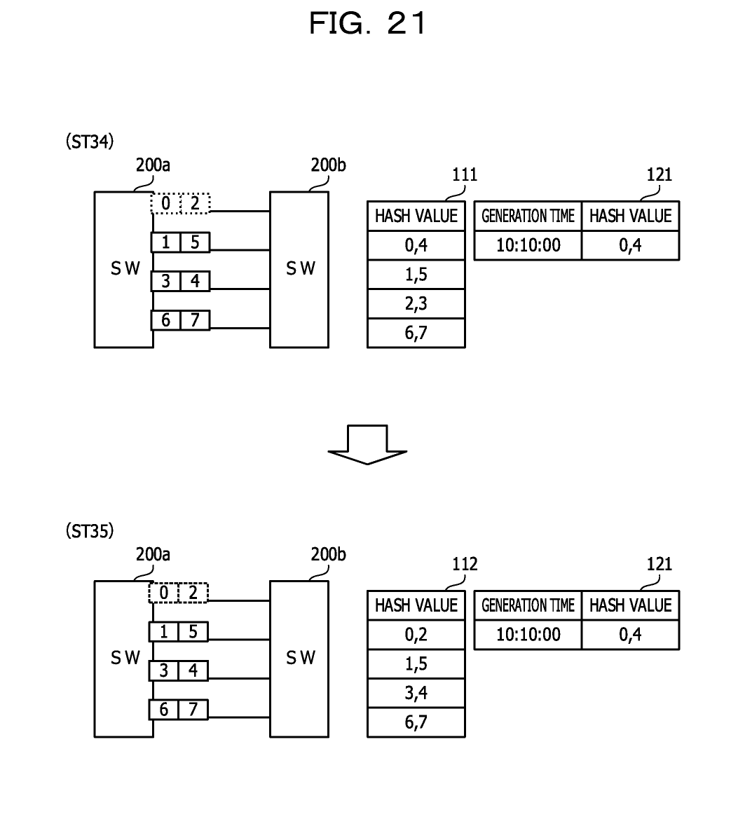

FIG. 21 is a (continuation of the third) monitoring example according to the third embodiment. Herein, the processes illustrated in FIG. 21 are described according to step numbers.

(ST34) The link-down of the physical link of the port number “1” is restored. The switches 200a and 200b sort the set of hash values (0, 2) to the physical link of the port number “1” (in the same rule as the sorting table 112). The monitoring server 100 detects the observation of the hash values (0, 2) is interrupted for a period of a predetermined length (for example, about 1 to several seconds). This is because, before the storage of the hash values “0” and “2” is changed to the physical link of the port number “1”, if the transmission of the packets associated with the hash values (0, 2) by the switches 200a and 200b is temporarily stopped. Then, the monitoring server 100 searches the set of hash values (0, 2) from the sorting table 111. However, the set of hash values (0, 2) does not exist in the sorting table 111. Therefore, the monitoring server 100 searches the set of hash values (0, 2) from the after-restoration sorting tables 112, 113, 114, and 115. The set of hash values (0, 2) exists in the sorting tables 112, 114, and 115, and associated with the port number “1”. Therefore, the monitoring server 100 determines that the physical link of the port number “1” went down, and registers the set of hash values (0, 4) to the failure management table 121 together with the current time.

(ST35) The monitoring server 100 detects the quality deterioration in the flow associated with the hash values “0” and “2” (there is no interruption in the same period as the observation of hash values for the respective flows). The monitoring server 100 checks that the set of hash values (0, 4) is registered to the failure management table 121, and the registration time is within a specific time in the past from the present moment (for example, within one hour).

Then, the monitoring server 100 switches the currently referred sorting table 111 to the after-restoration sorting table 112 of the physical link (associated with set of hash values (0, 4)) of the port number “1”. Also, the monitoring server 100 determines that the quality deterioration is caused by the physical link of LAG by using the sorting table 112. The set of hash values (0, 2) is registered to the sorting table 112 in association with the physical link of the port number “1”. Therefore, the monitoring server 100 determines the generation of the quality deterioration is caused by the physical link of the port number “1”. The monitoring server 100 notifies the quality deterioration section to the operator by displaying the determination result to the display 51.

In this manner, the monitoring server 100 may determine the change of the sorting rule by detecting that the observation of the set of hash values at the time of link restoration is interrupted for a period of a predetermined length, even if interruption of the set of hash values is not detected when the link-down is generated.

As described above, according to the monitoring server 100, the generation of the communication quality deterioration in the link aggregation section may be recognized based on the collected packets from any one of switches. Therefore, all switches of the network do not have to be examined (for example, the MIB information for failure monitoring is collected all the time from all switches), and the network is effectively monitored. In addition, it is possible to quickly specify which of the physical links in the link aggregation section causes the communication quality deterioration. Further, even if the sorting rule is changed in the link aggregation section, the erroneous detection of a quality deterioration section is suppressed and the accuracy of specifying the quality deterioration section may be improved.

Further, the monitoring server 100 supports the operator for the input of sorting rules for each vendor with the GUI 70. The operator may call the sorting rule according to the vendor by inputting the vendor identification information to the monitoring server 100 and set the sorting rule for monitoring. Therefore, a work of inputting a new sorting rule does not have to be forced to the operator, so as to achieve the labor saving of the operator.

Here, according to the third embodiment, there is provided an example in which one link aggregation section exists in the network, but plural link aggregation section may be exist. In addition, the packets may be transmitted in a manner of being included in a pay load of a MAC frame. Therefore, the switches 200a and 200b may decide from which of the physical links belonging to LAG, the MAC frame is sent, based on hash values according to sets of source MAC addresses and destination MAC addresses included in the MAC frame. The switches 200, 200a, 200b, and 200c may be layer 2 switches for transmitting MAC frames on Layer 2 of the OSI reference model (MAC frame may be referred to as packet). In that case, the monitoring server 100 may recognize the change of the sorting rule in the link aggregation section by the same manner as described above.

In addition, the information processing according to the first and second embodiments may be realized by executing programs on the operation unit 12. In addition, the information processing according to the third embodiment may be realized by executing programs on the processor 101. The programs may be recorded on the computer readable recording medium 53.

For example, the programs may be circulated by distributing the recording medium 53 on which the program is recorded. In addition, the programs may be stored in another computer, so as to be distributed via the network. The computer may store (install), for example, programs recorded on the recording medium 53, and programs received from another computer in a storage device such as the RAM 102 or the HDD 103, and read and execute the program from the storage device.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A monitoring device comprising:
a memory configured to store association information indicating associations between a set of indication values, which are calculated by a predetermined calculation of addresses included in packets, and a plurality of physical links used to transfer the packets, the packets being transferred between two relay devices through a link aggregation that forms a logical link by aggregating the plurality of physical links; and
a processor coupled to the memory and configured to:
collect the packets which are transferred through the logical link;
acquire the indication values of the collected packets in association with corresponding physical link;
determine whether or not the association information of the link aggregation is to be changed based on time interval of times at which a set of the acquired indication values, which is associated with one of the plurality of physical links, are acquired; and
change the association information stored in the memory in a case that the association information is determined to be changed.

2. The monitoring device according to claim 1, wherein
the processor is configured to determine that the association information of the link aggregation is to be changed in a case that the time interval is longer than a predetermined period.

3. The monitoring device according to claim 2,
wherein the memory is configured to further store restoration association information which is used to change the associated information after failure occurs in one of the plurality of physical links, and
the processor is configured to change contents of the association information with the restoration association information in a case that the time interval is longer than a predetermined period.

4. The monitoring device according to claim 1, wherein
the processor is configured to determine that the association information of the link aggregation is to be changed in a case that the time interval is longer than a predetermined period and a loss rate of the packets is equal to or greater than a threshold value.

5. The monitoring device according to claim 4,
wherein the memory is configured to further store restoration association information which is used to change the associated information after failure occurs in one of the plurality of physical links, and
the processor is configured to change the association information with the restoration association information in a case that the time interval is longer than a predetermined period and a loss rate of the packets is equal to or greater than a threshold value.

6. The monitoring device according to claim 1,
wherein the processor is configured to determine that the association information of the link aggregation is to be changed in a case that the time interval is longer than a predetermined period and only a portion of the set of the stored indication values matches a portion of the set of indication values stored in the memory.

7. A system comprising:
the monitoring device according to claim 1; and
a plurality of the relay devices.

8. A method comprising:
storing, in a memory, association information indicating associations between a set of indication values, which are calculated by a predetermined calculation of addresses included in packets, and a plurality of physical links used to transfer the packets, the packets being transferred between two relay devices through a link aggregation that forms a logical link by aggregating the plurality of physical links;
collecting the packets which are transferred through the logical link;
acquiring, by a processor, the indication values of the collected packets in association with corresponding physical link;
determining, by the processor, whether or not the association information of the link aggregation is to be changed based on time interval of times at which a set of the acquired indication values, which is associated with one of the plurality of physical links, are acquired; and
changing, by the processor, the association information stored in the memory in a case that the association information is determined to be changed.

9. The method according to claim 8, further comprising:
determining, by the processor, that the association information of the link aggregation is to be changed in a case that the time interval is longer than a predetermined period.

10. The method according to claim 9, further comprising:
storing, in the memory, restoration association information which is used to change the associated information after failure occurs in one of the plurality of physical links; and
changing, by the processor, contents of the association information with the restoration association information in a case that the time interval is longer than a predetermined period.

11. The method according to claim 8, further comprising:
determining, by the processor, that the association information of the link aggregation is to be changed in a case that the time interval is longer than a predetermined period and a loss rate of the packets is equal to or greater than a threshold value.

12. The method according to claim 11, further comprising:
storing, in the memory by the processor, restoration association information which is used to change the associated information after failure occurs in one of the plurality of physical links; and
changing, by the processor, the association information with the restoration association information in a case that the time interval is longer than a predetermined period and a loss rate of the packets is equal to or greater than a threshold value.

13. The method according to claim 8, further comprising:
determining, by the processor, that the association information of the link aggregation is to be changed in a case that the time interval is longer than a predetermined period and only a portion of the set of the stored indication values matches a portion of the set of indication values stored in the memory.

14. A non-transitory computer readable medium having stored therein a program that causes a computer to execute a process, the process comprising:
storing, in a memory, association information indicating associations between a set of indication values, which are calculated by a predetermined calculation of addresses included in packets, and a plurality of physical links used to transfer the packets, the packets being transferred between two relay devices through a link aggregation that forms a logical link by aggregating the plurality of physical links;
collecting the packets which are transferred through the logical link;
acquiring the indication values of the collected packets in association with corresponding physical link;
determining whether or not the association information of the link aggregation is to be changed based on time interval of times at which a set of the acquired indication values, which is associated with one of the plurality of physical links, are acquired; and
changing the association information stored in the memory in a case that the association information is determined to be changed.

15. The non-transitory computer readable medium according to claim 14, wherein the process further comprising:
determining that the association information of the link aggregation is to be changed in a case that the time interval is longer than a predetermined period.

16. The non-transitory computer readable medium according to claim 15, wherein the process further comprising:
storing, in the memory, restoration association information which is used to change the associated information after failure occurs in one of the plurality of physical links; and
changing contents of the association information with the restoration association information in a case that the time interval is longer than a predetermined period.

17. The non-transitory computer readable medium according to claim 14, wherein the process further comprising:
determining that the association information of the link aggregation is to be changed in a case that the time interval is longer than a predetermined period and a loss rate of the packets is equal to or greater than a threshold value.

18. The non-transitory computer readable medium according to claim 17, wherein the process further comprising:
storing, in the memory by the processor, restoration association information which is used to change the associated information after failure occurs in one of the plurality of physical links; and
changing the association information with the restoration association information in a case that the time interval is longer than a predetermined period and a loss rate of the packets is equal to or greater than a threshold value.

19. The non-transitory computer readable medium according to claim 14, wherein the process further comprising:
determining that the association information of the link aggregation is to be changed in a case that the time interval is longer than a predetermined period and only a portion of the set of the stored indication values matches a portion of the set of indication values stored in the memory.
